(19) United States
(12) Patent Application Publication
(10) Pub. No.: US 2026/0223267 A1
(43) Pub. Date: Jul. 30, 2026

(54) LUMINAIRE WITH DOUBLE GRADIENT RING

(71) Applicant: SIGNIFY HOLDING B.V., EINDHOVEN (NL)

(72) Inventors: TOBIAS BORRA, RIJSWIJK (NL); MALGORZATA PERZ, EINDHOVEN (NL); MICHEL CORNELIS JOSEPHUS MARIE VISSENBERG, ROERMOND (NL)

(21) Appl. No.: 19/147,280

(22) PCT Filed: Jan. 8, 2024
(86) PCT No.: PCT/EP2024/050284

§ 371 Date: Jul. 10, 2025

(30) Foreign Application Priority Data
Jan. 10, 2023 (EP) 23150829.2

(51) Int. Cl. H05B 47/155; F21V 3/00; F21V 23/04; F21Y 115/10; H05B 45/10; H05B 45/20; H05B 47/11; H05B 47/115; H05B 47/16; H05B 47/17

(52) U.S. Cl. CPC H05B 47/155; F21V 3/00; F21V 23/0471; H05B 45/10; H05B 45/20; H05B 47/11; H05B 47/115; H05B 47/16; H05B 47/17; F21Y 2115/10

(57) ABSTRACT

The invention provides a light generating system (1000) comprising a light emitting area (1100), wherein the light generating system (1000) is configured such that in a first operational mode of the light generating system (1000) first system light (1011) emanates from a first subarea (1110) of the light emitting area (1100), second system light (1021) emanates from a second subarea (1120) of the light emitting area (1100), and third system light (1131) emanates from a third subarea (1130) of the light emitting area (1100); wherein: the second subarea (1120) and the third subarea (1130) at least partially enclose the first subarea (1110), and wherein the third subarea (1130) at least partially encloses the second subarea (1120); one or more of a spectral power distribution and a luminance of the second system light (1021) comprises a second gradient over the second subarea (1120), having a second gradient direction and a second gradient magnitude m2; one or more of a spectral power distribution and a luminance of the third system light (1031) comprises a third gradient over the third subarea (1130), having a third gradient direction and a third gradient magnitude m3; and one or more of the following applies: (i) the second gradient direction and the third gradient direction are configured anti-parallel relative to each other and (ii) the second gradient and the third gradient have a different gradient magnitude, and (iii) the second gradient and the third gradient are shifted in phase relative to each other.

### FIELD OF THE INVENTION

The invention relates to a system to generate light. The invention further relates to a lighting device comprising such system to generate light.

### BACKGROUND OF THE INVENTION

Light systems utilizing gradients are known in the art. For instance, U.S. Pat. No. 3,922,073A describes a light diffuser system suspended from a ceiling below a light source including a framework of T-bar members depending from the ceiling and defining rectangular openings. Secured in each opening is a one-piece, translucent plastic light diffuser panel, formed in a coffer configuration with the cavity opening downward and the walls of the coffer inclined slightly from vertical toward the center of the opening. The walls are tapered from the bottom to the transverse portion, and are painted with an opaque color coating on the ceiling-facing surface. Light diffusing through the translucent, transverse portion strikes the walls, illuminating the color coating more strongly as the taper of the walls increases, and causing a color gradient effect which enhances the apparent depth of the coffer and increases the esthetic appeal of the diffuser system.

### SUMMARY OF THE INVENTION

Lighting devices are interesting for various applications including spots, stage-lighting, and home, and office lighting, etc. In current times, humans spend a large portion of their time indoors, for example during work or school hours. Exposure to daylight is vital to our health and such exposure may be limited by spending the majority of time indoors. Hence, it may be desired to provide exposure to daylight through artificial lighting means, such as skylights that provide the illusion of sunlight. Such artificial light generating systems may mimic at least certain aspects of an outdoor lighting environment and may provide the benefits thereof in an indoor setting, such as an office space. More and more lighting devices have been developed that function to provide lively light resembling the daylight. However, conventional lighting systems struggle to emulate natural sunlight in a dynamic manner. As a result, conventional lighting system may stand out from their environment, rather than become a natural part of the environment. Thus, there appears to be a desire for (improved) artificial light generating systems mimicking the dynamic aspects of sunlight.

Hence, it is an aspect of the invention to provide an alternative light generating system, which preferably further at least partly obviates one or more of above-described drawbacks. The present invention may have as object to overcome or ameliorate at least one of the disadvantages of the prior art, or to provide a useful alternative.

The invention is set out in the appended set of claims. According to a first aspect, the invention provides a light generating system (“system” or “lighting system”) comprising a light emitting area. Especially, the light generating system may, in embodiments, be configured such that in a first operational mode of the light generating system first system light emanates from a first subarea of the light emitting area, second system light emanates from a second subarea of the light emitting area, and third system light emanates from a third subarea of the light emitting area. Further, in embodiments, the second subarea and the third subarea may at least partially enclose the first subarea. Yet further in embodiments, the third subarea may at least partially enclose the second subarea. In embodiments, one or more of a spectral power distribution and a luminance of the second system light may comprise a second gradient over the second subarea. Especially, the second gradient may have a second gradient direction. More especially, the second gradient direction may be a (substantially) tangential direction, i.e. for a ring-shaped second subarea said tangential direction is in a circumferential direction over the circumference of the second subarea. Further, the second gradient may have a second gradient magnitude m2. Likewise, in embodiments, one or more of a spectral power distribution and a luminance of the third system light may comprise a third gradient over the third subarea. Especially, the third gradient may have a third gradient direction. More especially, the third gradient direction may be a (substantially) tangential direction, i.e. for a ring-shaped third subarea said tangential direction is in a circumferential direction over the circumference of the third subarea. Typically, each gradient comprises one period that extends over the respective full subarea, i.e. there is no repetition in gradient pattern in a respective subarea. Hence, a respective gradient can be seen as a single wave that extends over the full (circumference or length) of the respective subarea. Further, the third gradient may have a third gradient magnitude m3. In embodiments, one or more of the following may apply: (i) the second gradient direction and the third gradient direction may be configured anti-parallel or opposite, relative to each other, and (ii) the second gradient and the third gradient may have a (substantially) different gradient magnitude, and (iii) the second gradient and the third gradient may be shifted in phase relative to each other. In further embodiments, the light generating system may be configured to generate system light comprising first system light, second system light, and third system light. Especially, during operation of the light generating system, in embodiments, the system light may emanate from at least part of the light emitting area. Hence, in specific embodiments, the invention provides a light generating system comprising a light emitting area, wherein the light generating system may be configured such that, in a first operational mode of the light generating system, first system light emanates from a first subarea of the light emitting area, second system light emanates from a second subarea of the light emitting area, and third system light emanates from a third subarea of the light emitting area; wherein the second subarea and the third subarea at least partially enclose the first subarea, and wherein the third subarea at least partially encloses the second subarea; wherein one or more of a spectral power distribution and a luminance of the second system light comprises a second gradient over the second subarea, having a second gradient direction and a second gradient magnitude m2; wherein one or more of a spectral power distribution and a luminance of the third system light comprises a third gradient over the third subarea, having a third gradient direction and a third gradient magnitude m3; and wherein one or more of the following applies: (i) the second gradient direction and the third gradient direction are configured anti-parallel or opposite relative to each other and (ii) the second gradient and the third gradient have a different gradient magnitude, and (iii) the second gradient and the third gradient are shifted in phase relative to each other. Hence, the invention may provide a luminaire with double gradient visual effects. In the context of the invention the terms opposite or anti-parallel directions of gradients have to be understood as that one ring-shaped subarea has a gradient in the anticlock-wise direction and the other ring-shaped subarea has a gradient in the clock-wise direction. In the context of the invention the term parallel direction of gradients has to be understood as that both ring-shaped subarea simultaneously have a gradient in the anticlock-wise direction (or simultaneously have a gradient in the clock-wise direction).

With such a system it may be possible to provide lively and appealing light generating systems (e.g. luminaires) by capitalizing on illusions. In particular, the light from above prior is an interesting illusion embedded in the human visual system. This illusion comes down to the fact that we interpret light and shadow patterns to be a result from an overhead light source. As a result of this light from above prior effect two opposite gradients, rendered e.g. on two concentric rings, will be perceived as either a protruding edge/rim (convex), or a recessed edge/rim (concave). Hence, depending on the orientation of the gradient, a different percept arises. This percept is enhanced when the two rings are concentric and touch each other, i.e. are concentric without significant spacing (for example, a spacing less than 0.1 times, such as 0.03 times, the radial extension of the second or third subarea) or without observable spacing in between the concentric rings. This principle has statically been applied in a number of ways, e.g. for decorative tiling, wallpapers etc. However, embedding the light from above prior effect in light generating systems, through the implementation of a (dynamic) double gradient, may provide the benefit of providing a light generating system that feels like it is part of the surroundings, i.e., the system may be embedded in the environment rather than a separate entity. For example, the system may be dynamic in that the system light may be controlled in dependence of both time and outdoor lighting conditions. Controlling the system light in dependence of such variables may allow the light generating system to mimic the time dependence of the solar light. Hence, the proposed system using a double gradient may achieve a visual effect that resembles how we perceive sunlight much closer than conventional systems. Thus, the proposed system may achieve a visual effect that is perceived as more natural than conventional systems. Further, such a system may provide a visual 3D effect on a 2D object, i.e., a (substantially) 2D object may be perceived as having either a protruding edge/rim (i.e. a convex configuration), or a recessed edge/rim (i.e. a concave configuration). Hence, a (virtually) 2D light generating system visually appearing as a 3D system may be developed, which may provide the benefit of reduced bulk over a 3D light generating system. Thus, said light generating system may be particularly suitable for providing artificial sunlight mimicking light in smaller or cramped spaces. Hence, in embodiments, the invention may provide a luminaire with double gradient ring, i.e. typically two concentrically arranged gradient ring-shaped subareas. Especially, in embodiments, the invention may provide a luminaire with a double gradient ring, wherein the ring-shaped area could have a round, rectangular, a polygonal shape or a regular polygonal shape. Here below, first some general embodiments of the system are described, followed by some more specific embodiments. Further in the description, second and third (and further) ring-shaped area my be simply referred to as second, third and further subarea.

Especially, the light generating system may be configured to generate system light. As mentioned above, in embodiments, the light generating system may comprise a light emitting area. Further, during operation of the light generating system, the system light may especially emanate from at least part of the light emitting area.

In embodiments, the light emitting area may comprise a first subarea, a second subarea, and a third subarea. Especially, in embodiments, the second subarea and the third subarea may at least partially enclose the first subarea. More especially, in embodiments, the third subarea may (also) at least partially enclose the second subarea. Note that an area may refer to an enclosed space, and subarea may refer to another enclosed space which may be a subset of said area. The shape of the area may, in embodiments, be arbitrary. For instance, in embodiments, the area may comprise a circular cross-section, a square cross-section, polygonal cross-section, etc. The geometry of the area (as well as the subareas) is (are) discussed in further detail below.

As mentioned previously, the light generating system may in embodiments provide system light. Therefore, during operation of the light generating system, first system light may emanate from the first subarea, second system light may emanate from the second subarea, and third system light may emanate from the third subarea. Especially, the first system light, the second system light, and the third system light may essentially be comprised by the system light. More especially, the system light essentially consists of the first system light, the second system light, and the third system light.

In embodiments, the first system light, the second system light and the third system light may each have a spectral power distribution and a luminance. Further, one or more of the spectral power distribution and the luminance of the second system light may, in embodiments, comprise a second gradient over the second subarea. Yet further, one or more of the spectral power distribution and the luminance of the third system light may, in embodiments, comprise a third gradient over the third subarea. Especially, in embodiments, the first system light may not comprise or may be free from a gradient over the first subarea (see also further below). Thus, in embodiments, the second subarea and the third subarea may each have a shape, such as a circular shape or a rectangular shape, with a central point (P), configured in the first subarea, and the second subarea and the third subarea may each comprise one period of a gradient, such as a continuous gradient or a stepwise gradient, in a circumferential direction, also referred to as tangential direction. Typically, the gradients may only be in the circumferential direction and the subareas may be free from gradients in the radial direction and/or axial direction. For example, a circularly shaped subarea (e.g., a full circle of 360°) may have a continuous gradient or a stepwise gradient with steps of e.g. 30° relative to the central point (P) (see also further below). Likewise, a rectangularly shaped subarea may have a continuous gradient or a stepwise gradient with steps rotating from one segment to a next segment relative to the central point (P).

The term “gradient” may refer to a quantitative measure of the rate of change of a specific quantity with respect to a parameter. In the present context, the gradient may refer to the rate (or degree) of change of the luminance or the spectral power distribution with respect to a spatial direction. More especially, herein, the term “gradient” may refer to the rate of change of the luminance with respect to a spatial direction, especially an angular direction.

In embodiments, a luminance comprising a gradient may refer to a (substantially) continuous variation in the luminance from a lowest (or minimum) value to a highest (or maximum) value or to a variation of luminance from a lowest (or minimum) value to a highest (or maximum) value in discrete steps. Hence, the term “gradient” may be defined as a gradual or stepwise change from a subarea highest value to a subarea lowest value (of the luminance) in an angular direction. Especially, the subarea lowest value may be at least 10%, such as at least 12%, especially at least 15%, more especially at least 20% lower than the subarea highest value. More especially, the subarea lowest value may be at least 30%, such as at least 50%, especially at least 80%, more especially at least 90% lower than the subarea highest value. Hence, in embodiments, a luminance (measured in cd/m²) comprising a gradient over a subarea may be defined as a gradual or stepwise change from a subarea highest value to a subarea lowest value (of the luminance) in an angular direction. The term “subarea lowest value”, such as in a phrase like subarea lowest value of the luminance, and similar phrases, may refer to the lowest value in the subarea. The term “subarea highest value”, such as in a phrase like subarea highest value of the luminance, and similar phrases, may refer to the highest value in the subarea.

For example, referring to a change of the luminance in a spatial direction, the subarea highest value may be 60 cd/m² and the subarea lowest value may be 30 cd/m², or the subarea highest value may be 300 cd/m² and the subarea lowest value may be 30 cd/m². The spatial direction over which the gradient may occur, may especially be an angular direction over a specific subarea and may hence be dependent on a mutual angle (α) between the point of the subarea highest value and the point of the subarea lowest value relative to the central point (P). In embodiments, the mutual angle (α) may be at least 60°, such as at least 120°, especially at least 180°, including 360°. For example, in embodiments, the light emitting surface may comprise a second (or third) subarea spanning 135° of a circle (i.e. spanning a mutual angle (α) of 135°), and another second (or third) subarea spanning the other 225° of the circle (i.e. spanning a mutual angle (α) of) 225°. Likewise, in another example, the light emitting surface may comprise a second (or third) subarea spanning two sides of a square embodiment (i.e. spanning a mutual angle (α) of 180°), and another second (or third) subarea spanning the other two sides of the square embodiment (i.e. spanning a mutual angle (α) of 180°), see also further below regarding the figures. In a yet further example, the light emitting surface may comprise a second (or third) subarea spanning 135° of a ¾^{th} circle (i.e. spanning a mutual angle (α) of 135°), and another second (or third) subarea spanning another 135° of the ¾^{th} circle (i.e. spanning a mutual angle (α) of 135°).

The mutual angle (α) may, in embodiments of a stepwise gradient, be divided into smaller angles or gradient steps. In embodiments, a gradient step may thus be defined as a discrete increment within the mutual angle (α). Especially, in embodiments, the gradient step may be at most 120°, such as at most 90°, like at most 60°, especially at most 30°, such as 15°, including 10°. In further embodiments, the gradient step may (also) be at least 1°, such as at least 5°, especially at least 10°, such as 30°. Hence, in embodiments, a gradient step may be, for example, 1 cd/m² per 30° for a nightlight with an average luminance of 5 cd/m² and a mutual angle (α) of 150°.

In another example, the gradient step may (also) be 100 cd/m² per 12° for a luminaire with an average luminance of 1000 cd/m² and a mutual angle (α) of 120°. Especially, when the subarea may be a circular area, the gradient step may thus comprise an increase or decrease of 100 cd/m² per 12° of a ⅓^{rd} circle. In yet another example, a circular subarea of a luminaire with an average luminance of 1000 cd/m² and a mutual angle (α) of 180° (half a circle) may have a gradient step comprising an increase or decrease of 100 cd/m² per 18°, i.e., the luminance goes from 500 cd/m², to 1500 cd/m² in ten steps of 100 cd/m². In yet another example, a square subarea of a luminaire with an average luminance of 1000 cd/m² and a mutual angle (α) of 180° (half a square) may have a gradient step comprising an increase or decrease of 100 cd/m² per 18°, i.e., the luminance goes from 500 cd/m², to 1500 cd/m² in ten steps of 100 cd/m² In yet another example, a square subarea of a luminaire with an average luminance of 1000 cd/m² and a mutual angle (α) of 270° (¾^{th} square) may have a gradient step comprising an increase or decrease of 250 cd/m² per 90°, i.e., the luminance goes from 625 cd/m² to 1375 cd/m² in 3 steps of 250 cd/m².

Furthermore, a minimum difference in luminance between the subarea lowest and the subarea highest value may be 1 cd/m², especially 2 cd/m², more especially 10 cd/m², such as a minimum difference of 30 cd/m² (as is the case in one of the above mentioned examples), like a difference of 60 cd/m². Further, a minimum difference between the subarea lowest and the subarea highest value may be 100 cd/m², like a minimum difference of 150 cd/m², including a minimum difference of 300 cd/m². This minimum difference may especially be selected in consideration of the total average luminance of the light generating system. For example, a light generating system with a relatively high total average luminance (e.g. 800 cd/m²) may require a larger (absolute) difference between the subarea lowest and the subarea highest luminance (such as e.g. at least 50 cd/m²), whereas a light generating system with a relatively low total average luminance (e.g. 5 cd/m²) may do with a smaller (absolute) difference between the subarea lowest and the subarea highest luminance such as e.g. at least 1 cd/m².

Further, in embodiments the difference in luminance per gradient step, i.e., the difference in luminance per discrete increment within the mutual angle, may be defined as a minimum gradient step value. Especially, in embodiments, a minimum gradient step value may be 1 cd/m² per degree, such as 5 cd/m² per degree, like 10 cd/m² per degree, especially 20 cd/m² per degree, including 50 cd/m² per degree. Yet, in other embodiments, a minimum gradient step value may be 100 cd/m² per degree, such as 200 cd/m² per degree, including 500 cd/m² per degree. Such gradient step values are dependent on a combination of the size of the light emitting surface and the total average luminance of the light generating system. For example, in embodiments, a relatively small nightlight with an average luminance of 5 cd/m² may have a gradient step value of 1 cd/m² per degree, while for a relatively large luminaire with an average luminance of 1000 cd/m² a larger gradient step value is required, such as 100 cd/m² per degree.

In embodiments, the luminance comprising a gradient may have a minimum contrast between the subarea lowest value and the subarea highest value (or “extrema”) of the gradient of 1:2, such as 1:3, like 1:5, especially, 1:10, more especially 1:12, such as 1:15. The luminance comprising a gradient may have a maximum contrast between the subarea lowest value and the subarea highest value (or “extrema”) of 1:200, such as 1:100, like 1:50, especially 1:20. Hence, for example, for a lamp with a maximum (or highest) luminance of 300 cd/m² and a contrast between the extrema of 1:2, the lowest luminance value of the gradient may be 150 cd/m². In another example, a lamp may have a maximum (or highest) luminance of 500 cd/m² and a contrast between the extrema of 1:5, hence the lowest luminance value of the gradient may be 100 cd/m².

Hence, herein a gradient in luminance especially indicates a gradient in luminance while the spectral power distribution does essentially not change. Hence, especially over the second subarea, the spectral power distribution does not (substantially) change and/or over the third subarea, the spectral power distribution does not (substantially) change. Likewise, in embodiments over the first subarea, the spectral power distribution does not (substantially) change.

However, in specific embodiments the term “gradient” may herein (also) refer to the rate (or degree) of change of the magnitude of the color point. This may especially refer to changes in CIE 1931 x-value and/or y-value, or in CIE 1976 u′-value and/or v′-value. For example, in embodiments, the gradient may be rendered as a (continuous or stepwise) change from a red color point to a blue color point. Especially, a gradient in terms of color point may refer to: (a) a change from one color to another color, and (b) a change from color to white (or vice versa).

Colors may especially be selected from blue, green, yellow, orange, and red. However, in other embodiments colors may especially be selected from blue, green, yellow, orange, red, cyan, and amber

The terms “violet light” or “violet emission”, and similar terms, may especially relate to light having a wavelength in the range of about 380-440 nm. In specific embodiments, the violet light may have a centroid wavelength in the 380-440 nm range. The terms “blue light” or “blue emission”, and similar terms, may especially relate to light having a wavelength in the range of about 440-490 nm (including some violet and cyan hues). In specific embodiments, the blue light may have a centroid wavelength in the 440-490 nm range. The terms “green light” or “green emission”, and similar terms, may especially relate to light having a wavelength in the range of about 490-560 nm. In specific embodiments, the green light may have a centroid wavelength in the 490-560 nm range. The terms “yellow light” or “yellow emission”, and similar terms, may especially relate to light having a wavelength in the range of about 560-590 nm. In specific embodiments, the yellow light may have a centroid wavelength in the 560-590 nm range. The terms “orange light” or “orange emission”, and similar terms, may especially relate to light having a wavelength in the range of about 590-620 nm. In specific embodiments, the orange light may have a centroid wavelength in the 590-620 nm range. The terms “red light” or “red emission”, and similar terms, may especially relate to light having a wavelength in the range of about 620-750 nm. In specific embodiments, the red light may have a centroid wavelength in the 620-750 nm range. The terms “cyan light” or “cyan emission”, and similar terms, especially relate to light having a wavelength in the range of about 490-520 nm. In specific embodiments, the cyan light may have a centroid wavelength in the 490-520 nm range. The terms “amber light” or “amber emission”, and similar terms, may especially relate to light having a wavelength in the range of about 585-605 nm, such as about 590-600 nm. In specific embodiments, the amber light may have a centroid wavelength in the 585-605 nm range. The phrase “light having one or more wavelengths in a wavelength range” and similar phrases may especially indicate that the indicated light (or radiation) has a spectral power distribution with at least intensity or intensities at these one or more wavelengths in the indicate wavelength range. For instance, a blue emitting solid state light source will have a spectral power distribution with intensities at one or more wavelengths in the 440-495 nm wavelength range. White light is described below.

The term “centroid wavelength”, also indicated as λc, is known in the art, and refers to the wavelength value where half of the light energy is at shorter and half the energy is at longer wavelengths; the value is stated in nanometers (nm). It is the wavelength that divides the integral of a spectral power distribution into two equal parts as expressed by the formula λc=Σ λ*I(λ)/(Σ I(λ)), where the summation is over the wavelength range of interest, and I(λ) is the spectral energy density (i.e. the integration of the product of the wavelength and the intensity over the emission band normalized to the integrated intensity). The centroid wavelength may e.g. be determined at operation conditions.

As mentioned above, in embodiments, the second gradient may comprise a second gradient direction. Especially, the second gradient direction may be a (substantially) tangential direction. Furthermore, the second gradient may, in embodiments, have a second gradient magnitude m2 related to the difference between s second subarea lowest value and a second subarea highest value as described above. The gradient magnitude will be discussed in more detail further below. Likewise, in embodiments, the third gradient may comprise a third gradient direction. Especially, the third gradient direction may be a (substantially) tangential direction. Furthermore, the third gradient may, in embodiments, have a third gradient magnitude m3 related to the difference between a third subarea lowest value and a third subarea highest value as described above. The gradient magnitude will be discussed in more detail further below. Here, a tangential (or angular) direction may refer to a direction perpendicular to an (imaginary) radius from the central optical axis Aₒ to a respective point in the respective subarea, i.e. a clockwise or counterclockwise direction about the central optical axis Aₒ.

Further, in embodiments, one or more of the following may apply: (i) the second gradient direction and the third gradient direction may be configured anti-parallel relative to each other and (ii) the second gradient and the third gradient may have a (substantially) different gradient magnitude, and (iii) the second gradient and the third gradient may be shifted in phase relative to each other. Hence, especially in embodiments, the second gradient direction and the third gradient direction may be configured anti-parallel relative to each other, or especially in other embodiments, the second gradient and the third gradient may have a (substantially) different gradient magnitude, or especially in yet other embodiments the second gradient and the third gradient may be shifted in phase relative to each other, or especially in yet other embodiments a combination of these three may apply. This will be discussed in further detail below.

In embodiments, the light generating system may comprise a light emitting area. Especially, the light emitting area may be configured in a plane perpendicular to an optical axis Aₒ of the light generating system. Further, in embodiments, the light emitting area may comprise the central point (P), especially, the optical axis Aₒ may pass through the central point (P). Especially, the term “optical axis” (Aₒ) may be defined as an imaginary line that defines the path along which light propagates through a system starting from the light generating element. Especially, the optical axis may coincide with the direction of the light with the highest radiant flux. Furthermore, in embodiments, the optical axis may be defined perpendicular to the light emitting surface. Hence, in embodiments, the mutual angle between the point of the subarea highest value and the point of the subarea lowest value of a gradient may be relative to the optical axis Aₒ

As mentioned above, the light emitting area may have an arbitrary shape, for example, circular, rectangular, elliptical or polygonal. Especially, the light emitting area may have a circular or rectangular shape. Hence, the light emitting area may, in embodiments, have a regular shape. In other embodiments, the light emitting area may have an irregular shape. Furthermore, the first, second, and third subarea of the light emitting area may have shapes individually selected from rectangular, round, half-moon or crescent, ring, elliptical, and a regular polygon. However, despite such shapes, the light emitting surface may in embodiments be characterized with an equivalent circular diameter. The equivalent circular diameter (or ECD) (or “circular equivalent diameter”) of an (irregularly shaped) two-dimensional shape is the diameter of a circle of equivalent area. For instance, the equivalent circular diameter of a square with side a is 2*a*SQRT (1/π). For a circle, the diameter is the same as the equivalent circular diameter. Would a circle in an xy-plane with a diameter D be distorted to any other shape (in the xy-plane), without changing the area size, then the equivalent circular diameter of that shape would be D. Here, the circular equivalent diameter may be refer to the diameter of a circle with an area equal to the area of the light emitting surface. Hence, the light emitting area may, in embodiments, have an equivalent circular diameter selected from the range of 5 cm to 500 cm, such as from the range of 10 cm to 100 cm, like from the range of 25 cm to 75 cm.

In embodiments, the light generating system may be configured to generate system light. Especially, the system light may have a spectral power distribution in the range of visible light. Hence, the system light may have a spectral power distribution in the range of 380 nm-780 nm. In embodiments, the system light may comprise white light. However, in other embodiments, the system light may (also) comprise colored light. Further, in embodiments the system light emanating from different subareas may have different spectral power distributions. Features of the different colored light in embodiments and their corresponding wavelength ranges are defined further below. Furthermore, in embodiments, the system light may comprise one or more of UV light and IR light (see also further below).

Yet further, during operation of the light generating system, the system light may emanate from at least part of the light emitting area. Especially, in embodiments, the system light may emanate from at least 60% of the light emitting area, such as at least 70%, including at least 80%, such as at least 90%, especially at least 95%, more especially at least 98%, including 100% of the light emitting area. Hence, in embodiments, the system light may emanate from at least part of the light emitting area, or even essentially the entire light emitting area.

In embodiments, the light emitting area may comprise a first subarea, a second subarea, and a third subarea. Especially, the first, second, and third subarea may, in embodiments, be configured in a plane perpendicular to the optical axis Aₒ of the light generating system.

Further, in embodiments, the second subarea may at least partially enclose the first subarea. The first subarea may have a first outer edge face. The second subarea may have a second inner edge face and a second outer edge face. Hence, in embodiments, the first outer edge face and the second inner edge face may face each other along at least part of their length. Especially, in embodiments, the first outer edge face and the second inner edge face may face each other along 30% of their length, such as along 40%, like along 50%, especially along 60%, such as along 70%, including along 80%, especially along 90%, more especially along 95%, such as along 99%. In specific embodiments, the second subarea may fully enclose the first subarea. Hence, in such embodiments, the first outer edge face and the second inner edge face may face each other along their full length, i.e., the first outer edge face and the second inner edge face may 100% face each other. For example, the first subarea may have a square cross-section and the second subarea may surround the square cross-section of the first subarea such that the second inner edge face faces the first outer edge face only on three sides.

Similarly, in embodiments, the third subarea may at least partially enclose the second subarea. The third subarea may have a third inner edge face and a third outer edge face. Hence, in embodiments, the second outer edge face and the third inner edge face may face each other along at least part of their length. Especially, in embodiments, the second outer edge face and the third inner edge face may face each other along 30% of their length, such as along 40%, like along 50%, especially along 60%, such as along 70%, including along 80%, especially along 90%, more especially along 95%, such as along 99%. In specific embodiments, the third subarea may fully enclose the second subarea. Hence, in such embodiments, the second outer edge face and the third inner edge face may face each other along their full length, i.e., the second outer edge face and the third inner edge face may 100% face each other. For example, the second subarea may have a square cross-section (surrounding the first subarea) and the third subarea may surround the square cross-section of the second subarea such that the third inner edge face faces the second outer edge face only on three sides.

The “lengths” as described here may be defined as the total length (or circumference, in embodiments where the subarea comprises a circle or ring) of the (inner or outer) face of the respective subarea in a plane perpendicular to the central optical axis Aₒ.

In embodiments, the light generating system may be operable in a single operational mode or may be operable in two or more modes of operation. Hence, the manner in which the light generating system may be configured may in embodiments be varied. Further, it may in embodiments also be possible to control or switch between different operational modes. In embodiments, the light generating system may comprise a control system that may control the operational mode(s) of the light generating system. Such features of the light generating system are discussed further below.

The system may comprise a control system or may be functionally coupled to a control system. The control system may especially be configured to control the light generating system. For instance, the control system may control the light generating system in dependence of a sensor signal, a time scheme (or timer), or a user input (signal), see also further below.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc., Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

Hence, the light generating system may be configured such that in a first operational mode of the light generating system, a first system light may emanate from the first subarea, a second system light may emanate from the second subarea, and a third system light may emanate from the third subarea. Here below, the second system light, and the third system light are discussed; later the first system light is further discussed.

The second system light may, in embodiments, have a spectral power distribution in the range of visible light. Especially, the second system light may have a spectral light distribution in the range of 380 nm-780 nm. In embodiments, the second system light may comprise white light. In yet other embodiments, the second system light may comprise colored light. In yet other embodiments, the second system light may comprise UV light (see also further below). Further, the second system light may, in embodiments, have an average luminance selected from the range of 5-10000 cd/m², such as from the range of 5-5000 cd/m², like from the range of 5-800 cd/m², especially from the range of 30-500 cd/m², like from the range of 50-300 cd/m². Especially, in embodiments, one or more of the spectral power distribution and the luminance of the second system light, such as the spectral power distribution, or such as the luminance, or especially such as both the spectral power distribution and the luminance of the second system light, may comprise a second gradient over the second subarea. The second gradient may be defined as described above. More especially, the second gradient may have a second gradient direction and a second gradient magnitude m2. The second gradient direction may especially, in embodiments, be a (substantially) tangential direction.

The third system light may, in embodiments, have a spectral power distribution in the range of visible light. Especially, the third system light may have a spectral light distribution in the range of 380 nm-780 nm. In embodiments, the third system light may comprise white light. In yet other embodiments, the third system light may comprise colored light. In yet other embodiments, the third system light may comprise UV light (see also further below). Further, the third system light may, in embodiments, have an average luminance selected from the range of 5-10000 cd/m², such as from the range of 5-5000 cd/m², like from the range of 5-800 cd/m², especially from the range of 30-500 cd/m², like from the range of 50-300 cd/m². Especially, in embodiments, one or more of the spectral power distribution and the luminance of the third system light, such as the spectral power distribution, or such as the luminance, or especially such as both the spectral power distribution and the luminance of the third system light may comprise a third gradient over the third subarea. The third gradient may be defined as described above. More especially, the third gradient may have a third gradient direction and a third gradient magnitude m3. The third gradient direction may especially, in embodiments, be a (substantially) tangential direction.

In embodiments, a gradient direction may be a linear direction or an angular direction (or a radial direction).

The term “linear direction” may refer to a direction or “vector” in a three dimensional Cartesian coordinate system, wherein the z-axis may coincide with the optical axis Aₒ of the light generating system and the light emitting area may be configured in an xy-plane (comprising the origin) perpendicular to the optical axis Aₒ. In such a system, the linear direction may, for example, be defined by the vector that crosses through the origin from a negative value to a positive value (or from a positive value to a negative value).

In embodiments, the luminance of the second system light may comprise the second gradient and the luminance of the third system light may comprise the third gradient. In such embodiments, the gradient direction of the second gradient and the third gradient may both be defined as a gradient direction from the highest luminance value to the lowest luminance value, or may both be defined as a gradient direction from the lowest luminance value to the highest luminance value. Thus, the gradient direction of the second gradient and the third gradient are defined equally.

Further, in embodiments, the gradient may show variation in a radial direction about an axis (for example the optical axis Aₒ).

In embodiments, the second gradient direction may be a linear direction, an angular direction, or a radial direction. Likewise, in embodiments, the third gradient direction may be a linear direction, an angular direction, or a radial direction. Especially, in embodiments, the second gradient direction and the third gradient direction may both be a linear direction. In other embodiments, the second gradient direction and the third gradient direction may both be an angular direction. In yet other embodiments, the second gradient direction and the third gradient direction may both be a radial direction. Hence, especially, the gradient directions are of the same type.

In embodiments where the second gradient direction and the third gradient direction may both be linear directions, the second gradient direction and the third gradient direction may not be configured parallel. For example, in such embodiments, the second gradient direction and the third gradient direction may be configured in one of the following manners: antiparallel, perpendicular, rotated relative to each other.

Hence, in embodiments, the second gradient direction and the third gradient direction may be configured anti-parallel relative to each other, while the second gradient and the third gradient may have the same gradient magnitude and are not phase-shifted relative to each other. In other embodiments, the second gradient and the third gradient may have a different gradient magnitude, while the second gradient direction and the third gradient direction may be configured parallel and not phase-shifted relative to each other. In yet other embodiments, the second gradient and the third gradient may be phase shifted relative to each other, while the second gradient direction and the third gradient direction may be configured parallel relative to each other and the second gradient and third gradient may have the same gradient magnitude. In yet other embodiments, the second gradient direction and the third gradient direction may be configured anti-parallel and the second gradient and third gradient may have a different gradient magnitude; or the second gradient direction and the third gradient direction may be configured parallel and phase-shifted relative to each other; or the second gradient and the third gradient may have a different gradient magnitude and the second gradient and third gradient may be phase-shifted relative to each other. In yet other embodiments, the second gradient direction and the third gradient direction nay be configured anti-parallel relative to each other, and the second gradient and third gradient may have a different gradient magnitude, and the second gradient and third gradient may be phase-shifted relative to each other.

Hence, the second gradient direction and the third gradient direction may, in embodiments, be rotated relative to each other to create a phase shift, i.e., the second gradient and the third gradient are shifted in phase relative to each other. Especially, in embodiments, the second gradient direction and the third gradient direction may be configured phase-shifted with an angle selected from the range of 90-270° relative to each other, such as with an angle of 150-210° relative to each other, especially with an angle of 170-190° relative to each other. More especially, in embodiments, the second gradient direction and the third gradient direction may be configured phase-shifted with an angle of 180° relative to each other. In a specific embodiment, the second gradient direction and the third gradient direction are configured parallel and are phase-shifted with an angle of 180° relative to each other.

Hence, in embodiments where, where the second gradient direction and the third gradient direction are configured parallel, the second gradient direction and the third gradient direction have a location of peak luminance (and/or peak spectral power distribution) rotated (or phase shifted) with an angle of 90-270° relative to each other, such as with an angle of 150-210° relative to each other, especially with an angle of 170-190° relative to each other. Especially, in embodiments where the second gradient direction and the third gradient direction are configured parallel, the second gradient direction and the third gradient direction have a location of peak luminance (and/or peak spectral power distribution) rotated with an angle of 180° relative to each other.

Hence, in embodiments the light emitting area may comprise a circular shape. In such embodiment, the second gradient direction and the third gradient direction may be configured rotated relative to each other such that a phase shift may be created. Hence, the second gradient direction and the third gradient direction may be phase-shifted with an angle selected from the range of 90-270° relative to each other. However, in other embodiments, the light emitting area may comprise a square or rectangular shape. In such embodiments, the second gradient direction and the third gradient direction may be configured rotated relative to each other in a discrete sense, i.e., the different luminance values may be rotated in discrete steps along the circumference of the respective area.

Further, in embodiments, one of the second gradient direction and the third gradient direction may be configured clockwise, while the other may be configured counterclockwise. Hence, the second gradient direction and the third gradient direction may, in embodiments, be configured anti-parallel relative to each other.

Yet further, in embodiments, the second direction and the third gradient direction may not be the same type. Hence, in embodiments, one of the second gradient direction and the third gradient direction may especially be a linear direction, while the other may be an angular direction.

Rotation (or phase-shifting) as discussed above may occur in embodiments where the second gradient direction and the third gradient direction may both be linear directions. However, similar rotation may (also) occur in embodiments where the second gradient direction and the third gradient direction may both be angular directions, i.e., the locations of peak luminance and/or spectral power distribution of the second gradient and the third gradient may be rotated relative to each other.

In embodiments, the second gradient direction and the third gradient direction may both be linear directions. Especially, in embodiments, the second gradient direction and the third gradient direction may be configured anti-parallel. Hence, in embodiments, the second gradient direction and the third gradient direction may be linear directions configured anti-parallel relative to each other, i.e., the second gradient direction and the third gradient direction may be linear directions configured opposite each other.

In embodiments, the light generating system may have a central point (P). Especially, in embodiments, the central point (P) may be configured in the first subarea.

Furthermore, a gradient may have a highest value (luminance) and a lowest value (luminance). Especially, in embodiments, the lowest luminance may be located at a first position and the highest luminance may be located at a second position.

Hence, a gradient magnitude may herein be defined by a difference in luminance ΔL between the first position (in the respective subarea) having a lowest luminance and the second position (in the same respective subarea) having a highest luminance divided by a mutual angle (α) between the first position and the second position relative to the central point (P) in the first subarea. In embodiments, especially, the second gradient magnitude m2 may be defined by a difference in luminance ΔL2 between a first position in the second subarea having a lowest second luminance and a second position in the second subarea having a highest second luminance divided by a mutual angle (α2) between the first position and the second position relative to the central point (P) in the first subarea. More especially, L21/L22≤0.5, such as L21/L22≤0.25, like L21/L22≤0.1. Further, in embodiments, the third gradient magnitude (m3) may be defined by a difference in luminance ΔL3 between a first position in the third subarea having a lowest second luminance and a second position in the third subarea having a highest second luminance divided by a mutual angle (α3) between the first position and the second position relative to the central point (P) in the first subarea. Especially, L31/L32≤0.5, such as L31/L32≤0.25, like L31/L32≤0.1. Hence, in specific embodiments, the second gradient and the third gradient are defined tangential; wherein the second gradient magnitude m2 is defined by a difference in luminance ΔL2 between a first position in the second subarea having a subarea lowest second luminance L21 and a second position in the second subarea having a subarea highest second luminance L22 divided by a mutual angle (α2) between the first position and the second position relative to a central point (P) in the first subarea, wherein L21/L22≤0.5, and/or wherein the third gradient magnitude m3 is defined by a difference in luminance ΔL3 between a first position in the third subarea having a subarea lowest third luminance L31 and a third position in the third subarea having a subarea highest third luminance L32 divided by a mutual angle (α3) between the first position and the third position relative to the central point (P) in the first subarea, wherein L31/L32≤0.5

In relative terms, the gradient magnitude may comprise the contrast of lowest value:highest value (i.e., lowest luminance (L21/L31):highest luminance (L22/L32)), such as a minimum contrast of 1:2, such as 1:3, like 1:5, especially, 1:10, more especially 1:12, such as 1:15. Further, the gradient magnitude may comprise a maximum contrast of 1:200, such as 1:100, like 1:50, especially 1:20.

In absolute terms, for example, the light generating system may have (a) an overall maximum (or highest) luminance of 500 cd/m², (b) a second gradient magnitude m2 comprising a contrast of 1:2, (c), a third gradient magnitude m3 (especially determined over the same mutual angle (α) as the second gradient magnitude m2) comprising a contrast of 1:5, and (d) a ratio m2/m3=5/8. Hence, in embodiments, the second gradient may have a second subarea highest (or maximum) luminance L22 of (for example, about) 500 cd/m² and a second subarea lowest (or minimum) luminance L21 of (about) 250 cd/m², whereas the third gradient may have a third subarea highest (or maximum) luminance L32 of (for example, about) 500 cd/m² and a third subarea lowest (or minimum) luminance L31 of (about) 100 cd/m². In another example, in embodiments, the light generating system may have (a) an overall maximum luminance of 400 cd/m², (b) a second gradient magnitude m2 comprising a contrast of 1:2, (c), a third gradient magnitude m3 (especially determined over the same mutual angle (α) as the second gradient magnitude m2) comprising a contrast of 1:4, and (d) a ratio m2/m3=1/2. Hence, in embodiments, the second gradient may have a second subarea highest (or maximum) luminance L22 of (for example, about) 300 cd/m² and a second subarea lowest (or minimum) luminance L21 of (about) 150 cd/m², whereas the third gradient may have a third subarea highest (or maximum) luminance L32 of (for example, about) 400 cd/m² and a third subarea lowest (or minimum) luminance L31 of (about) 100 cd/m².

Furthermore, in embodiments, the mutual angles (α2, α3) may be individually selected from the range of 0-360°, but especially from the range of 90-270°, such as from the range of 120-240°, like from the range of 150-210°.

In embodiments, the second gradient magnitude m2 and the third gradient magnitude m3 may be (essentially) the same gradient magnitude, i.e., m2-m3. Especially, in embodiments where the second gradient direction and the third gradient direction are (substantially) different (i.e., configured anti-parallel relative to each other and/or with a non-zero phase shift), the second gradient magnitude m2 and the third gradient magnitude m3 may be (essentially) the same, i.e., m2=m3.

In other embodiments, the second gradient magnitude m2 and the third gradient magnitude m3 may be different. For example, in embodiments, the second gradient magnitude m2 and the third gradient magnitude m3 may be different when the second gradient direction and the third gradient direction may be configured parallel and (essentially) the same direction (i.e., with the same location of peak luminance and/or spectral power distribution, i.e., without a phase-shift relative to each other).

Hence, in embodiments, the second gradient magnitude m2 and the third gradient magnitude m3 may be (substantially) different, i.e., m2≠m3. Especially, in such embodiments, the second gradient magnitude m2 and the third gradient magnitude m3 may differ by at least 10%, such as at least 30%, especially at least 50%, like at least 70%, including at least 90%. In embodiments, one or more of the following may apply: m2/m3≥1.1 or m3/m2≥1.1, such as m2/m3≥1.25 or m3/m2≥1.25, like m2/m3≥1.5 or m3/m2≥21.5, especially m2/m3≥1.75 or m3/m2≥1.75. In specific embodiments, m2/m3≥3/2 or m2/m3≤2/3. Especially, m2/m3≥3/2 or m2/m3≤2/3, wherein the gradient magnitude is defined as described above.

In embodiments, the second gradient direction and the third gradient direction may be phase-shifted relative to each other, and the second gradient and the third gradient may have a (substantially) different gradient magnitude. Per example, in specific embodiments, the second gradient direction and the third gradient direction may be phase-shifted with an angle of 90° relative to each other, and m2/m3=0.5, i.e., the second gradient magnitude m2 may be half of the third gradient magnitude m3.

In embodiments, the light emitting area may comprise a central part and a peripheral part. The peripheral part may, in embodiments, at least partially enclose the central part. In embodiments, the peripheral part may essentially fully enclose the central part. Further, in embodiments, the central part may comprise the first subarea. In such embodiments, the peripheral part may especially comprise the second subarea and the third subarea. Especially, in embodiments, an area of the peripheral part may be selected from the range of 1-75%, such as 1-50%, of a total area of the light emitting area. In (alternative) embodiments, the area of the peripheral part may be selected from the range of 50-99% of the total area of the light emitting area. Hence, in specific embodiments, the light emitting area may comprise a central part and a peripheral part, at least partially enclosing the central part, wherein the central part may comprise the first subarea, and wherein the peripheral part may comprise the second subarea and the third subarea; wherein an area of the peripheral part may be selected from the range of 1-75%, more especially 1-50%, of a total area of the light emitting area.

The light emitting area, as indicated above, may comprise the first, second and third subarea. The first subarea may especially, in embodiments, be comprised by a central part of the light emitting area. Furthermore, in embodiments, the second and third subarea of the light emitting area may especially be comprised by a peripheral part of the light emitting area. Hence, in embodiments, the light emitting area may comprise a central part and a peripheral part. Especially, the peripheral part may at least partially enclose the central part of the light emitting area. More especially, in embodiments, the peripheral part may fully enclose the central part of the light emitting area. Hence, in embodiments, the central part may comprise the first subarea, the peripheral part may enclose the central part and may comprise the second and the third subarea, wherein the second subarea may especially be configured between the first and the third subarea.

Especially, in embodiments, an area of the peripheral part, such as for example the second subarea or the third subarea, may be selected from the range of 1-50% of a total area of the light emitting area, such as from the range of 5-40%, like from the range of 15-30%. In (alternative) embodiments, the area of the peripheral part, such as for example the second subarea or the third subarea, may also be selected from the range of 50-99%, such as from the range of 60-90%, like from the range of 65-85%. Hence, in embodiments, the second subarea may have an area selected from the range of 0.1-49.9% of the total area of the light emitting area, such as from the range of 0.5-49.5%. Likewise, in embodiments, the third subarea may have an area selected from the range of 0.1-49.9% of the total area of the light emitting area, such as from the range of 0.5-49.5%. Hence, in a specific embodiment, the second subarea and the third subarea may have an equal area selected from the range of 0.1-49.9% of the total area of the light emitting area, for example the second and the third subarea may both have an area of 25% of the total area of the light emitting area. However, in other embodiments, the second subarea and the third subarea may have an unequal area (individually) selected from the range of 0.1-49.9% of the total area of the light emitting area, such as from the range of 0.5-49.5%.

In embodiments, the peripheral part of the light emitting area may comprise the second subarea and the third subarea, especially the second subarea and the third subarea may have a ratio of 1:1 within the peripheral part. In other embodiments, the second subarea and the third subarea may have a ratio within the range of 1:2-2:1, such as 1:2, or such as 2:1 within the peripheral part. In yet other embodiments, the second subarea and the third subarea may have a ratio within the range of 1:3-3:1, such as 1:3, or such as 3:1 within the peripheral part. In yet other embodiments, the second subarea and the third subarea may have a ratio within the range of 2:3-3:2, such as 2:3, or such as 3:2, within the peripheral part.

Per example, in embodiments where the light emitting area may have an equivalent circular diameter of 100 cm, and the central part and peripheral part may both comprise 50% of the light emitting area, the central part and the peripheral part may have an equivalent circular diameter of 50 cm. In such embodiments, the second subarea and the third subarea may, e.g., both have an area of 25% of the total area of the light emitting area, and hence, the second subarea and the third subarea may both have an equivalent circular diameter of 25 cm.

In embodiments, the central part, comprising the first subarea, and the peripheral part, comprising the second and third subarea, may have a shape individually selected from rectangular, round, half-moon or crescent, ring, elliptical, and a regular polygon.

In embodiments, the peripheral part, comprising the second and third subarea, may at least partially enclose the central part, comprising the first subarea. Especially, in embodiments, the first, second and third subarea may be sequentially adjacent. In specific embodiments, the second subarea may fully enclose the first subarea (i.e., may fully enclose the central part), and the third subarea may fully enclose the second (and hence the first) subarea (i.e. the peripheral part may fully enclose the central part). Especially, in specific embodiments, the first, second and third subarea may be round (or ring-shaped) and substantially concentric around the (central) optical axis (Ao). Hence, in such embodiments, the central part and the peripheral part may be round (or ring-shaped) and substantially concentric around the (central) optical axis (Ao). In other embodiments, the first, second and third subarea may be rectangular, wherein the second subarea may at least partially (or even fully) enclose the first subarea and the third subarea may at least partially (or even fully) enclose the second subarea. Hence, in such embodiments, the central part and the peripheral part may be rectangular and the peripheral part may at least partially (or even fully) enclose the central part.

In embodiments, the light generating system may comprise one or more first light generating devices configured to generate first device light. The first device light may especially, in embodiments, be comprised by the first system light. Further, in embodiments, the one or more first light generating devices may comprise one or more solid state light sources. Especially, the one or more first light generating devices may comprise one or more first solid state light sources. More especially, the one or more first light generating devices may comprise a plurality of first solid state light sources.

In embodiments, the light generating system may (also) comprise one or more second light generating devices configured to generate second device light. The second device light may especially, in embodiments, be comprised by the second system light. Further, in embodiments, the one or more second light generating devices may comprise a plurality of solid state light sources. Especially, the one or more second light generating devices may comprise a plurality of second solid state light sources.

In embodiments, the light generating system may (also) comprise one or more third light generating devices configured to generate third device light. The third device light may especially, in embodiments, be comprised by the third system light. Further, in embodiments, the one or more third light generating devices may comprise a plurality of solid state light sources. Especially, the one or more third light generating devices may comprise a plurality of third solid state light sources.

In specific embodiments, the light generating system may comprise a 2D array of solid state light sources. Especially, the said 2D array of solid state light sources may comprise the one or more (first) solid state light sources, the plurality of (second) solid state light sources, and the plurality of (third) solid state light sources. Hence, in specific embodiments, the light generating system may comprise (i) one or more first light generating devices configured to generate first device light, wherein the first system light comprises the first device light; (ii) one or more second light generating devices configured to generate second device light, wherein the second system light comprises the second device light; wherein the one or more second light generating devices comprise a plurality of solid state light sources; and (iii) one or more third light generating devices configured to generate third device light, wherein the third system light comprises the third device light, wherein the one or more third light generating devices comprise a plurality of solid state light sources. Especially, all light generating devices comprise solid state light sources (see also further below).

Such embodiments may provide the benefit of operating the light generating system in a variety of operational modes. For example, in embodiments, in an operational mode solely the one or more first light generating devices may provide system light. Likewise, there may also be (other) operational modes for providing system light from solely the one or more second or the one or more third light generating devices, or from a combination thereof. Hence, such embodiments may improve controllability of the system light through introducing variability in the operation of different light generating devices in different subareas. This variability in the operation of the light generating devices may for example include variation in intensity, gradient direction, and gradient magnitude. In other embodiments, the size of the respective areas may be controlled.

In embodiments the light generating devices may comprise solid-state light sources. Especially, the light generating devices may be selected from the group comprising a LED, a laser, and a COB. As indicated above, the light generating system comprises a light generating device. A light generating device may especially be configured to generate device light. Especially, the light generating device may comprise a light source. The light source may especially configured to generate light source light. In embodiments, the device light may essentially consist of the device light. In other embodiments, the device light may essentially consist of converted light source light. In yet other embodiments, the device light may comprise (unconverted) light source light and converted light source light. Light source light may be converted with a luminescent material into luminescent material light and/or with an upconverter into upconverted light (see also below). The term “light generating device” may also refer to a plurality of light generating devices which may provide device light having essentially the same spectral power distributions. In specific embodiments, the term “light generating device” may also refer to a plurality of light generating devices which may provide device light having different spectral power distributions.

The term “light source” may in principle relate to any light source known in the art. It may be a conventional (tungsten) light bulb, a low pressure mercury lamp, a high pressure mercury lamp, a fluorescent lamp, an LED (light emissive diode). In a specific embodiment, the light source comprises a solid state LED light source (such as an LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be an outer surface of a glass or a quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc. The term “light source” may also refer to an organic light-emitting diode (OLED), such as a passive-matrix (PMOLED) or an active-matrix (AMOLED). In a specific embodiment, the light source comprises a solid-state light source (such as an LED or laser diode). In an embodiment, the light source comprises an LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as an LED, or downstream of a plurality of solid-state light sources (i.e. e.g. shared by multiple LEDs). In embodiments, the light source may comprise an LED with on-chip optics. In embodiments, the light source comprises pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise or may be free from a luminescent material (“phosphor”) may be indicated as direct color LEDs.

In other embodiments, however, the light source may be configured to provide primary radiation and part of the primary radiation is converted into secondary radiation. Secondary radiation may be based on conversion by a luminescent material. The secondary radiation may therefore also be indicated as luminescent material radiation. The luminescent material may in embodiments be comprised by the light source, such as an LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as an LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape) and a spectral power distribution. The light source light may in embodiments comprise one or more bands, having band widths as known for lasers

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The term “light source” may (thus) in embodiments also refer to a light source that is (also) based on conversion of light, such as a light source in combination with a luminescent converter material. Hence, the term “light source” may also refer to a combination of an LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like an LED, and an optical filter, which may change the spectral power distribution of the light generated by the light source. Especially, the term “light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a diode laser, or a superluminescent diode.

Hence, in embodiments, the light generating system may comprise one or more first light generating devices, such as at least two first light generating devices. In embodiments, the one or more first light generating devices may be configured upstream of the first subarea (and/or the central part) of the light emitting area. The one or more first light generating devices may be configured to generate first device light. For example, in embodiments, the one or more first light generating devices may individually comprise a single solid state light source. In other embodiments, the one or more first light generating devices may individually comprise multiple solid state light sources.

Further, in embodiments, the light generating system may comprise one or more second light generating devices, such as one second light generating device, like two second light generating devices, including three second light generating devices. In embodiments, the one or more second light generating devices may be configured within the second subarea (and/or the peripheral part) of the light emitting area. Furthermore, in embodiments, the one or more second light generating devices may comprise a plurality of (second) solid state light sources, selected from the range of 2-1000 solid state light sources, such as 10-500, like 25-100 solid state light sources.

Yet further, in embodiments, the light generating system may comprise one or more third light generating devices, such as one third light generating device, like two third light generating devices, including three third light generating devices. In embodiments, the one or more third light generating devices may be configured within the third subarea (and/or the peripheral part) of the light emitting area. Furthermore, in embodiments, the one or more third light generating devices may comprise a plurality of (third) solid state light sources, selected from the range of 2-1000 solid state light sources, such as 10-500, like 25-100 solid state light sources.

In embodiments, the one or more second light generating devices may comprise LED filaments. In other embodiments, the one or more second light generating devices may comprise LED strips. In yet other embodiments, the one or more second light generating devices may comprise both LED filaments and LED strips. Likewise, in embodiments, the one or more third light generating devices may comprise LED filaments. In other embodiments, the one or more third light generating devices may comprise LED strips. In yet other embodiments, the one or more third light generating devices may comprise both LED filaments and LED strips. Hence, in a specific embodiment, the one or more second light generating devices may comprise one or more of (a) a LED filament and (b) a LED strip; and the one or more third light generating devices may comprise one or more of (a) a LED filament and (b) a LED strip.

Such embodiments may be beneficial as they made provide ease of assembly. The use of filaments or strips over individual LED's may increase the efficiency of the production of the light generating system.

In embodiments, the light generating devices may comprise LED filaments. In embodiments, the second light generating devices may comprise LED filaments. Likewise, in embodiments, the third light generating devices may comprise LED filaments. Further, the first light generating devices may, in embodiments, (also) comprise LED filaments.

In yet further embodiments, the light generating devices may comprise LED strips. In embodiments, the second light generating devices may comprise LED strips. Likewise, in embodiments, the third light generating devices may comprise LED strips. Further, the first light generating devices may, in embodiments, (also) comprise LED strips.

In embodiments, the (second and/or third) gradient may comprise a continuous gradient over a single light generating device (e.g. a LED filament or strip). Hence, the light generating device may comprise at least three solid state light sources to provide a (luminance) gradient. In other embodiments, the (second and/or third) gradient may comprise a segmented gradient over multiple light generating devices (e.g. LED filaments or strips). Hence, the light generating system comprises multiple light generating devices comprising at least one solid state light source to provide an intersegmental (luminance) gradient. In yet other embodiments, (second and/or third) gradient may comprise a continuous gradient over multiple light generating devices (e.g. LED filaments or strips). Hence, the light generating system comprises multiple light generating devices comprising at least 3 solid state light sources to provide an intersegmental and intersegmental (luminance) gradient.

The light generating devices may, in embodiments, comprise LED's, especially LED's configured in a 2D array. Hence, in embodiments, the light generating system may comprise a 2D array of solid state light sources. Especially, in such embodiments, the 2D array of solid state light sources may comprise the one or more (first) solid state light sources, the plurality of (second) solid state light sources, and the plurality of (third) solid state light sources. In embodiments, the second and third solid state light sources may especially comprise at least three solid state light sources to provide the (luminance) gradient.

In yet further embodiments, the light generating devices may comprise a printed circuit board (or “PCB”) and solid state light sources (e.g. LED's) functionally coupled to the PCB. In embodiments, the second light generating devices may comprise a PCB comprising solid state light sources. Likewise, in embodiments, the third light generating devices may comprise a PCB comprising solid state light sources. Further, the first light generating devices may, in embodiments, (also) comprise a PCB comprising solid state light sources.

In embodiments, the one or more second light generating devices may enclose the one or more first light generating devices. Further, in embodiments, the one or more third light generating devices may enclose the one or more second light generating devices. Hence, in a specific embodiment, the one or more second light generating devices may enclose the one or more first light generating devices, and the one or more third light generating devices may enclose the one or more second light generating devices.

In embodiments, the one or more first light generating devices, the one or more second light generating devices, and the one or more third light generating devices may comprise the same type of light generating devices (e.g. LED filaments). However, in other embodiments, the one or more first light generating devices, the one or more second light generating devices, and the one or more third light generating devices may comprise different types of light generating devices. For example, the light emitting area may comprise the central part comprising a central lamp surrounded by the peripheral part comprising a plurality of LED filaments or LED strips as second and third light generating devices.

Hence, in embodiments, where the one or more first, second and third light generating devices comprise LED's in a (2D) LED array, the light generating devices (i.e., the LED's) may for example comprise an n×m array. In embodiments, the one or more first light generating devices (i.e., the one or more first LED's) may comprise a 2×2 array. In such embodiments, the one or more second light generating devices (i.e., the one or more second LED's) may fully enclose the 2×2 array of one or more first light generating devices to form in an exemplary embodiment a 4×4 array. Yet further, in such embodiments, the one or more third light generating devices (i.e., the one or more third LED's) may fully enclose the one or more second light generating devices and the one or more first light generating devices to form a 6×6 array. However, in other embodiments, the second light generating devices may (only) partially enclose the one or more first light generating devices, and/or the one or more third light generating devices may (only) partially enclose the one or more second light generating devices.

In embodiments, where the one or more (first) second, and third light generating devices comprise LED strips (and/or LED filaments), the one or more second LED strips (and/or LED filaments) may (at least partially, especially fully) enclose the one or more first light generating devices. And further, in embodiments, the one or more third LED strips (and/or LED filaments) may (at least partially, especially fully) enclose the one or more second LED strips (and/or LED filaments).

Especially, in embodiments, the one or more first light generating devices may be configured in the central part of the light emitting area, and the one or more second and one or more third light generating devices may be configured in the peripheral part of the light emitting area. And hence, in such embodiments, wherein the peripheral part (at least partially, especially fully) encloses the central part, the one or more second and one or more third light generating devices may (at least partially, especially fully) enclose the first light generating devices.

It may be desirable to use a diffuser, e.g. to better hide the light generating devices from the view and/or to make the light more homogenous. Such embodiments may provide the benefit of allowing the light generating system to generate soft light. Soft light may especially be desired for use of the light generating system in for example home or office settings.

Hence, in embodiments, the light generating system may comprise a diffuser. Especially, the diffuser may, embodiments, be configured downstream of the one or more first light generating devices, the one or more second light generating devices, and the one or more third light generating devices. More especially, in embodiments, the diffuser may comprise the light emitting area, i.e., first, second, and third subarea may comprise a shared diffuser. Hence, in specific embodiments, the light generating system may comprise a diffuser, wherein the diffuser may be configured downstream of the one or more first light generating devices, the one or more second light generating devices, and the one or more third light generating devices, and wherein the diffuser may comprise the light emitting area.

The diffuser may comprise a material configured to diffuse the system light, such as, in embodiments, ground glass, Teflon, opal glass, greyed glass, silk, and translucent plastics.

In embodiments, the light generating system may comprise bare light generating devices. In other embodiments, however, the light generating system may comprise a diffuser configured downstream of the light emitting area and as such covering the (first, second, and third) light generating devices with a shared diffuser. In yet other embodiments, the first, second and third light generating devices may be comprised by separate chambers (defined by the first, second, and third subareas) with separate diffusers configured downstream of the respective first, second and third light generating devices. Especially, in embodiments with a diffuser, the light generating system may provide light with a more homogeneous gradient effect.

The terms “upstream” and “downstream” relate to an arrangement of items or features relative to the propagation of the light from a light generating means (here the especially the light source), wherein relative to a first position within a beam of light from the light generating means, a second position in the beam of light closer to the light generating means is “upstream”, and a third position within the beam of light further away from the light generating means is “downstream”.

In embodiments, the light emitting area and the diffuser may be configured together in a housing. Especially, the diffuser may be functionally coupled to the light emitting area. Further, in embodiments, the diffuser may comprise (at least part of) the light emitting area. In embodiments, the light emitting area may comprise the first subarea, the second subarea and the third subarea. Hence, the diffuser may be functionally coupled to (at least part of) the first subarea, the second subarea, and the third subarea. In a specific embodiment, the diffuser may comprise the full light emitting area, and hence may be functionally coupled to the first subarea, the second subarea, and the third subarea.

The second subarea may, in embodiments, be divided into two or more segments, i.e., the second subarea may comprise two or more second segments. In such embodiments, the two or more second segments may each comprise one or more second light generating devices. Hence, in embodiments, in the first operational mode, second system light may emanate from the two or more second segments. Especially, in embodiments, the second system light emanating from the two or more second segments may (substantially) differ in one or more of spectral power distribution and luminance, such as especially the spectral power distribution, or especially the luminance, or (even) both. Hence, in embodiments, the two or more second segments may have a spectral power distribution and a luminance, which may be individually distinct. In some embodiments, the two or more second segments may not have an intersegmental gradient, i.e., the two or more second segments may have a uniform value of luminance. Especially, the two or more second segments may each have a different uniform value of luminance. Hence, the two or more second segments may contribute to the second gradient solely through intersegmental differences in luminance (and/or spectral power distribution). For example, in embodiments, the one or more second segments may each comprise a LED strip (or a LED filament) with a different uniform value of luminance.

In other embodiments, the two or more second segments may have an (additional) intersegmental gradient, i.e., the two or more second segments may have a non-uniform value of luminance. Especially, the two or more second segments may each have an internal gradient of luminance. Hence, the two or more second segments may contribute to the second gradient through both intersegmental and intersegmental differences in luminance (and/or spectral power distribution). For example, in embodiments, the one or more second segments may each comprise at least three LED's with different values of luminance to provide an internal gradient. In another example, in embodiments, the one or more second segments may each comprise a LED strip (or a LED filament) with internal variation of the luminance (i.e., with at least three different LED's with different values of luminance) to provide an internal gradient. In yet another example, in embodiments, the one or more second segments may each comprise multiple LED strips (or LED filaments) with different uniform values of luminance to provide an internal gradient.

Furthermore, the third subarea may, in embodiments, be divided into two or more segments, i.e., the third subarea may comprise two or more third segments. In such embodiments, the two or more third segments may each comprise one or more third light generating devices. Hence, in embodiments, in the first operational mode, third system light may emanate from the two or more third segments. Especially, in embodiments, the third system light emanating from the two or more third segments may (substantially) differ in one or more of spectral power distribution and luminance, such as especially the spectral power distribution, or especially the luminance, or (even) both. Hence, in embodiments, the two or more third segments may have a spectral power distribution and a luminance, which may be individually distinct.

In some embodiments, the two or more third segments may not have an intersegmental gradient, i.e., the two or more third segments may have a uniform value of luminance. Especially, the two or more third segments may each have a different uniform value of luminance. Hence, the two or more third segments may contribute to the third gradient solely through intersegmental differences in luminance (and/or spectral power distribution). For example, in embodiments, the one or more third segments may each comprise a LED strip (or a LED filament) with a different uniform value of luminance.

In other embodiments, the two or more third segments may have an (additional) intersegmental gradient, i.e., the two or more third segments may have a non-uniform value of luminance. Especially, the two or more third segments may each have an internal gradient of luminance. Hence, the two or more third segments may contribute to the third gradient through both intersegmental and intersegmental differences in luminance (and/or spectral power distribution). For example, in embodiments, the one or more third segments may each comprise at least three LED's with different values of luminance to provide an internal gradient. In another example, in embodiments, the one or more third segments may each comprise a LED strip (or a LED filament) with internal variation of the luminance (i.e., with at least three different LED's with different values of luminance) to provide an internal gradient. In yet another example, in embodiments, the one or more third segments may each comprise multiple LED strips (or LED filaments) with different uniform values of luminance to provide an internal gradient.

In embodiments the light generating system may comprise a control system. Especially, the control system may, in embodiments, be configured to control the first system light. Further, in embodiments, the control system may be configured to control the second system light. Yet further, in embodiments, the control system may be configured to control the third system light. Hence, the light generating system may, in embodiments, comprise a control system configured to control one or more of (the first) the second, and the third system light.

The control system may thus, in embodiments, be configured to control the first system light, i.e., one or more first light generating devices. More especially, the control system may be configured to control the second system light, i.e. the one or more second light generating devices, and the third system light, i.e. the one or more third light generating devices. For instance, the control system may be configured to control one or more of the luminance, the spectral power distribution, the gradients and the operational mode of the light generating system (i.e., of the system light). In embodiments, the control system may at least be configured to control the luminance of the second system light and the luminance of the third system light.

Hence, in embodiments, the control system may be configured to control the second system light. Especially, the control system may, in embodiments, be configured to control one or more of the luminance of the second system light and the spectral power distribution of the second system light, such as especially the luminance, or such as the spectral power distribution, or (even) such as both. The control system may, for example, control the intersegmental gradient of second light generating devices comprised by the second segments to rotate the direction of the second gradient.

Further, in embodiments, the control system may be configured to control the third system light. Especially, the control system may, in embodiments, be configured to control one or more of the luminance of the third system light and the spectral power distribution of the third system light, such as especially the luminance, or such as the spectral power distribution, or (even) such as both. The control system may, for example, control the intersegmental luminance values of third light generating devices comprised by the third segments to rotate the direction of the third gradient.

In yet further embodiments, the control system may (also) be configured to control the first system light. Especially, the control system may, in embodiments, be configured to control one or more of the luminance of the first system light and the spectral power distribution of the first system light, such as especially the luminance, or such as the spectral power distribution, or (even) such as both. The control system may, for example, control the luminance of the first system light to provide dimming of the system light.

Herein, controlling the luminance of the system light may refer to controlling the overall luminance, or the luminance comprising the gradient. Hence, in embodiments, the control system may control the gradient direction and/or the gradient magnitude of a gradient (such as the second gradient, or such as the third gradient) comprised by the luminance.

Further, controlling the spectral power distribution of the system light may herein refer to controlling the overall spectral power distribution, or the gradient comprising the spectral power distribution. Hence, in embodiments, the control system may control the gradient direction and/or the gradient magnitude of a gradient (such as the second gradient, or such as the third gradient) comprising the spectral power distribution.

In embodiments, the control system may be configured to control the (first system light, the) second system light, and the third system light. Especially, the control system may be configured to, in embodiments, control the (first system light, the) second system light, and the third system light in dependence of one or more of time and outdoor lighting conditions. Additionally or alternatively, the control system may be configured to, in embodiments, control the (first system light, the) second system light, and the third system light in dependence of indoor lighting conditions. Hence, in specific embodiments, the control system may be configured to control the second system light, and the third system light in dependence of one or more of time and outdoor lighting conditions.

Such embodiments may be beneficial as it allows for the operation of the light generating system in a daylight resembling manner, i.e., the light generating system may function in correspondence to natural lighting rhythms (such as the circadian rhythm) based on for example time and the sun. The control system may for example change the gradient directions or gradient magnitudes of the second and third gradient in correspondence to natural lighting rhythms, i.e., the control system may vary the location and/or value of the peak intensity of light based on the position of the sun. In such a way, the light generating system may become more a part of the surrounding environment rather than a separate entity. Furthermore, by enabling a user to control the light generating system in dependence of time, the light generating system may become more energy (and thus cost) efficient, as the system may be activated, deactivated and adjusted in intensity based on the need of the user.

The control system may, in embodiments, be configured to control the second system light and/or the third system light in dependence of time. Alternatively or additionally, the control system may be configured to control the second system light and/or the third system light in dependence of outdoor lighting conditions. In specific embodiments, the control system may be configured to control the second system light and the third system light in dependence of both time and outdoor lighting conditions. Controlling the system light in dependence of such variables may allow the light generating system to mimic the time dependence of the solar light.

Further, in embodiments, it may also be desired to provide a light generating system that operates interactively with other light generating devices present in close vicinity to the light generating system. Hence, in such embodiments, the control system may be configured to control (the first system light) the second system light and the third system light in dependence of indoor lighting conditions.

In embodiments, the light generating system may further comprise a sensor. The sensor may, in embodiments, be configured to sense one or more of presence and movement of a human or other light sources. Especially, in embodiments, the sensor may be configured to sense the presence of a human (or other light sources). More especially, in embodiments, the sensor may be configured to sense the movement or a human (or other light sources). In a specific embodiment, the sensor may be configured to sense both the presence and the movement of a human (or other light sources). Further, in embodiments, the sensor may generate a sensor signal related to the sensed presence and/or movement of a human. In embodiments, the control system may be configured to control (the first system light) the second system light and the third system light in dependence of the sensor signal. Hence, in specific embodiments, the light generating system may comprise a sensor, wherein the sensor may be configured to sense one or more of presence and movement of a human and to generate a related sensor signal, wherein the control system may be configured to control the second system light, and the third system light in dependence of the sensor signal.

In embodiments, the sensor may also be configured to generate a sensor signal related to one or more of (a) time (scheme) and user input. The sensor, in embodiments, may especially be functionally coupled with the control system. In embodiments, the sensor may be comprised by the control system.

Hence, in embodiments, the control system may be configured to control (the first system light) the second system light and the third system light in dependence of a sensor signal, especially the sensor signal.

In embodiments, the first system light may be white light. In other embodiments, the first system light may be colored light. In yet other embodiments, the first system light may comprise a display.

In embodiments, in the first operational mode of the light generating system, the first system light may be white light, and the second and third system light may be other light, such as colored light or UV light. However, in such embodiments, the second and third system light may also be white light, especially white light with a (substantially) similar color point to the first system light.

In embodiments, in the first operational mode of the light generating system, the first system light may have a color point within 20 standard deviation of color matching from the black body locus. Further, in such embodiments, the second system light may (also) have a color point within 20 standard deviation of color matching from the black body locus. Yet further, in such embodiments, the third system light may (also) have a color point within 20 standard deviation of color matching from the black body locus. Hence, in the first operational mode of the light generating system, in a specific embodiment, the first system light, the second system light, and the third system light may all have a color point within 20 standard deviation of color matching from the black body locus. Further, in embodiments, one or more of, especially both the spectral power distribution and the luminance of the first system light may not comprise or may be free from a first gradient over the first subarea. Hence, in specific embodiments, both the spectral power distribution and the luminance of the first system light may not comprise or may be free from a gradient over the first subarea. Especially, in embodiments, the first gradient may have a first gradient magnitude m1 smaller than the second gradient magnitude m2 and the third gradient magnitude m3. More especially, m1/m2≤0.1 and/or m1/m3≤0.1, such as m1/m2≤0.01 and/or m1/m3≤0.01. Especially, the first gradient magnitude is essentially zero.

In embodiments, in the first operational mode of the light generating system, the first system light may have a color point within 20 standard deviation of color matching from the black body locus, such as within 15 standard deviation of color matching, like within 10 standard deviation of color matching, especially within 7 standard deviation of color matching.

Further, in such embodiments, the second system light may (also) have a color point within 20 standard deviation of color matching from the black body locus, such as within 15 standard deviation of color matching, like within 10 standard deviation of color matching, especially within 7 standard deviation of color matching.

Yet further, in such embodiments, the third system light may (also) have a color point within 20 standard deviation of color matching from the black body locus, such as within 15 standard deviation of color matching, like within 10 standard deviation of color matching, especially within 7 standard deviation of color matching.

Hence, in such embodiments, the system light may comprise white light. However, in other embodiments, the system light may (also) comprise colored light. In yet other embodiments, the system light may (also) comprise UV light.

In specific embodiments, in the first operational mode of the light generating system, the first system light, the second system light, and the third system light may all have the same color point, i.e., the color point of the first system light, the second system light, and the third system light may be (essentially) equal. Especially, in such embodiments, the luminance of the second system light may comprise the second gradient over the second subarea, and the luminance of the third system light may comprise the third gradient over the third subarea. More especially, in such embodiments, (one or more of, especially) both the spectral power distribution and the luminance of the first system light may not exhibit a gradient over the first subarea. Hence, especially the spectral power distribution of the first system light may not exhibit a first gradient over the first subarea, or especially the luminance of the first system light may not exhibit a first gradient over the first subarea, or especially both the spectral power distribution and the luminance of the first system light may not exhibit a first gradient over the first subarea.

In other specific embodiments, colors or color points of a first type of light and a second type of light may be essentially the same when the respective color points of the first type of light and the second type of light differ with at maximum 0.03 for u′ and/or with at maximum 0.03 for v′, even more especially at maximum 0.02 for u′ and/or with at maximum 0.02 for v′. In yet more specific embodiments, the respective color points of first type of light and the second type of light may differ with at maximum 0.01 for u′ and/or with at maximum 0.01 for v′. Here, u′ and v′ are color coordinate of the light in the CIE 1976 UCS (uniform chromaticity scale) diagram.

The light generating system may be part of or may be applied in e.g. office lighting systems, household application systems, shop lighting systems, home lighting systems, accent lighting systems, spot lighting systems, theater lighting systems, fiber-optics application systems, self-lit display systems, pixelated display systems, segmented display systems, warning sign systems, indicator sign systems, decorative lighting systems, portable systems, automotive applications, (outdoor) road lighting systems, urban lighting systems, green house lighting systems, or horticulture lighting. The light generating system (or luminaire) may be part of or may be applied in e.g. disinfection systems.

The term “white light”, and similar terms, herein, is known to the person skilled in the art. It may especially relate to light having a correlated color temperature (CCT) between about 1800 K and 20000 K, such as between 2000 and 20000 K, especially 2700-20000 K, for general lighting especially in the range of about 2000-7000 K, such as in the range of 2700 K and 6500 K. In embodiments, e.g. for backlighting purposes, or for other purposes, the correlated color temperature (CCT) may especially be in the range of about 7000 K and 20000 K. Yet further, in embodiments the correlated color temperature (CCT) is especially within about 15 SDCM (standard deviation of color matching) from the BBL (black body locus), especially within about 10 SDCM from the BBL, even more especially within about 5 SDCM from the BBL.

In specific embodiments, the correlated color temperature (CCT) may be selected from the range of 6000-12000 K, like selected from the range of 7000-12000 K, like at least 8000 K. Yet further, in embodiments the correlated color temperature (CCT) may be selected from the range of 6000-12000 K, like selected from the range of 7000-12000 K, in combination with a CRI of at least 70.

The terms “visible”, “visible light” or “visible emission” and similar terms refer to light having one or more wavelengths in the range of about 380-780 nm. Herein, UV may especially refer to a wavelength selected from the range of 190-380 nm, such as 200-380 nm.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to (at least) visible light.

In yet a further aspect, the invention also provides a lamp or a luminaire comprising the light generating system as defined herein. The luminaire may further comprise a housing, optical elements, louvres, etc, etc. The lamp or luminaire may further comprise a housing enclosing the light generating system. The lamp or luminaire may comprise a light window in the housing or a housing opening, through which the system light may escape from the housing Hence, in an aspect the invention also provides a light generating device selected from the group of a lamp, a luminaire, and a disinfection device, comprising the light generating system as defined herein. The light generating device may comprise a housing or a carrier, configured to house or support, one or more elements of the light generating system. For instance, in embodiments the light generating device may comprise a housing or a carrier, configured to house or support one or more of the one or more first, second and third light generating devices.

In a further aspect, the invention may provide an indoor space. The space may in embodiments comprise one or more of a wall, slanted wall, room divider, roof, slanted roof and ceiling. Especially the indoor space may further comprise the light generating system suspended from the roof, slanted roof, ceiling wall, slanted wall, or room divider. In other embodiments, the light generating system may be physically attached to the ceiling or wall by means of screws or fasteners. Hence, in this way, the light generating system may be functionally coupled to the ceiling or wall. Further, in embodiments, the light generating system may illuminate the indoor space with system light.

The term “indoor space” or “space” may for instance relate to a (part of) hospitality area, such as a restaurant, a hotel, a clinic, or a hospital, etc., The term “space” may also relate to (a part of) an office, a department store, a warehouse, a cinema, a church, a theatre, a library, etc. However, the term “space” may also relate to (a part of) a working space in a vehicle, such as a cabin of a truck, a cabin of an air plane, a cabin of a vessel (ship), a cabin of a car, a cabin of a crane, a cabin of an engineering vehicle like a tractor, a cabin of a train carriage, etc. The term “space” may also relate to (a part of) a working space, such as an office, a (production) plant, a power plant (like a nuclear power plant, a gas power plant, a coal power plant, etc.), etc. For instance, the term “space” may also relate to a control room, a security room, etc. Especially, the term “space” may herein refer to an indoor space. In yet other embodiments, the term “space” may also relate to a toilet room or bathroom. In yet other embodiments, the term “space” may also relate to an elevator. In embodiments, the term “space” may also refer to a conference room, a school room, an indoor hallway, an indoor corridor, an indoor space in an elderly home, an indoor space in a nursing home, etc. In embodiments, the term “space” may refer to an indoor sport space, like a gym, a gymnastics hall, in indoor ball sport space, a ballet room, a swimming pool, a changing room, etc. In embodiments, the term “space” may refer to an (indoor) bar, an (indoor) disco, etc.

Further, in embodiments, the indoor space may comprise the control system and sensor. Embodiments of such have been described further above.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1A-B schematically depicts embodiments of the light generating system 1000 and some general aspects;

FIG. 2 schematically depicts some more specific embodiments of the light generating system 1000;

FIG. 3 schematically depicts some further aspects of the invention; and

FIG. 4. schematically depicts an embodiment of an application.

The schematic drawings are not necessarily to scale.

### DETAILED DESCRIPTION OF THE EMBODIMENTS

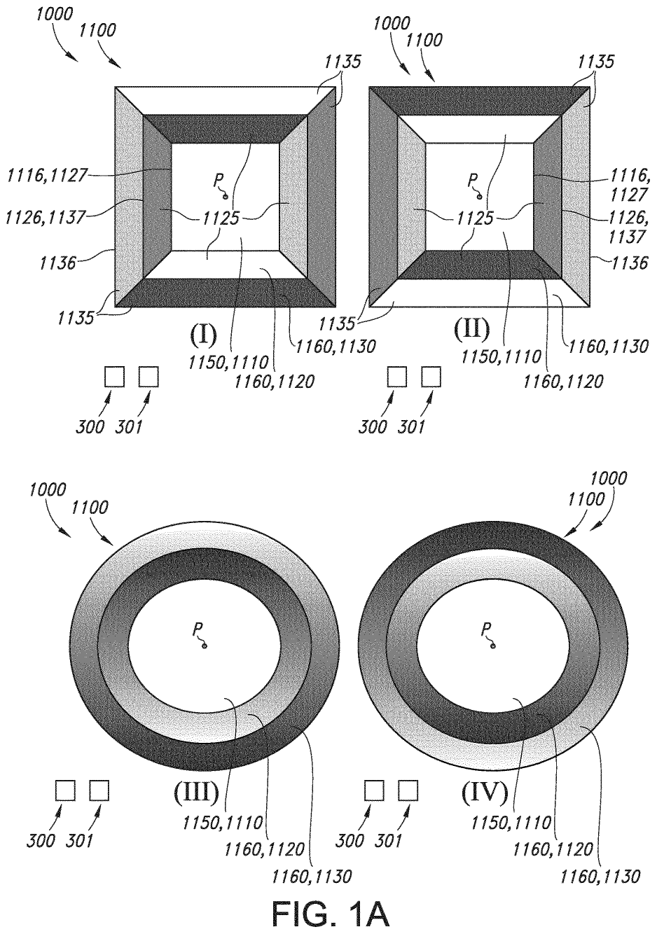

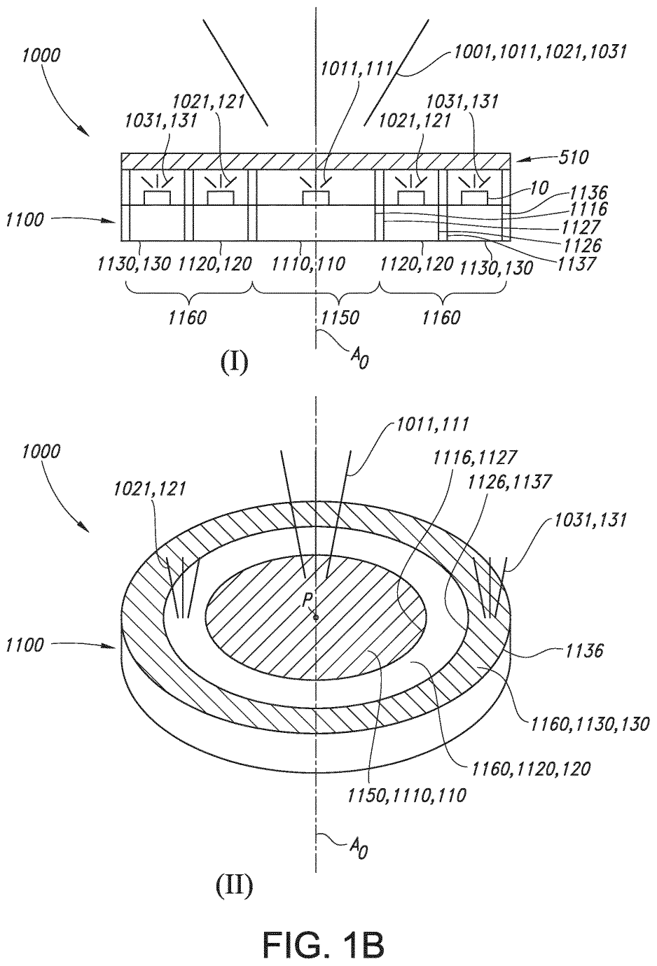

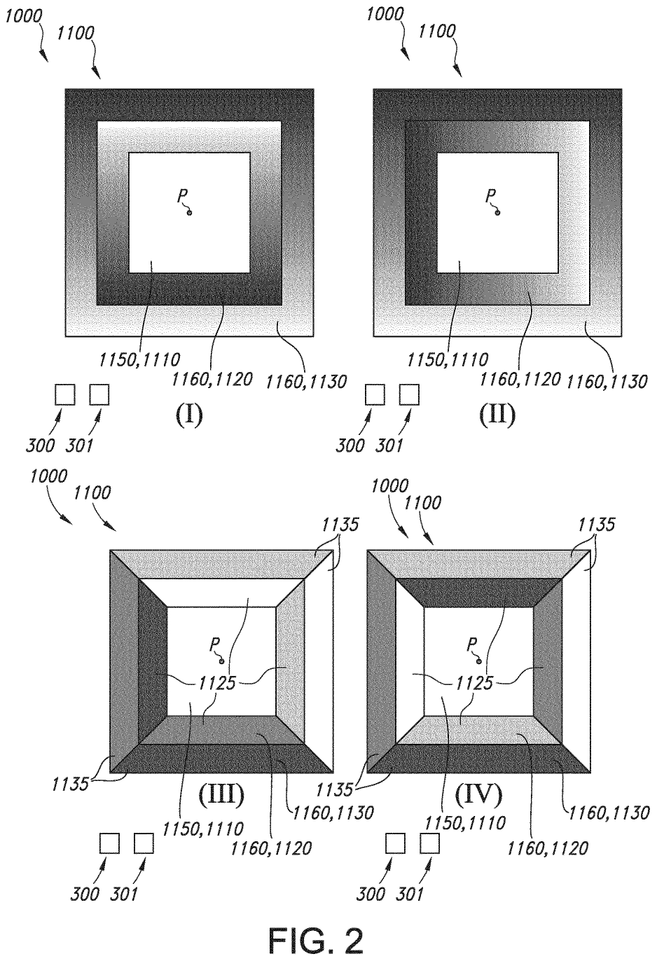

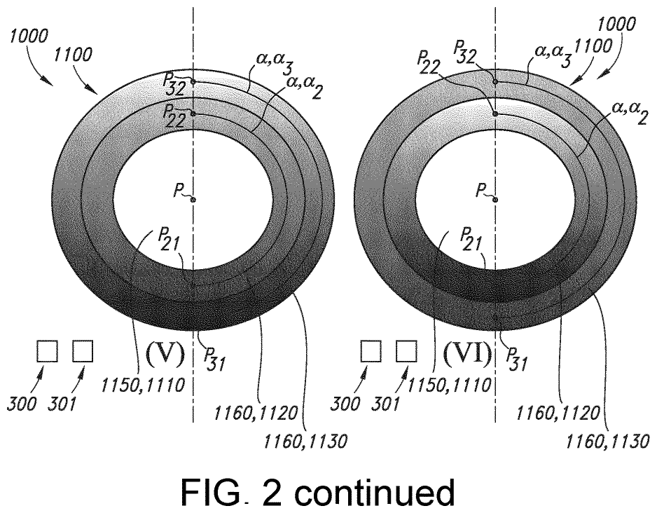

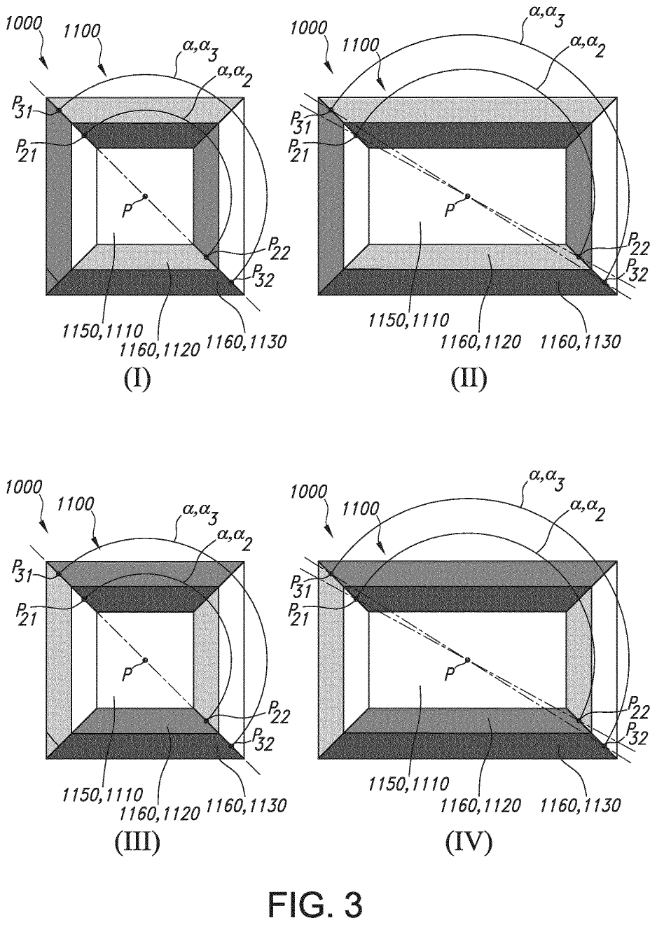

FIG. 1A-B schematically depicts embodiments of the invention. In embodiments, the invention may be a light generating system (“system”) 1000 comprising a light emitting area 1100. Especially, the light generating system 1000 may, in embodiments, be configured such that in a first operational mode of the light generating system 1000 first system light 1011 emanates from a first subarea 1110 of the light emitting area 1100, second system light 1021 emanates from a second subarea 1120 of the light emitting area 1100, and third system light 1031 emanates from a third subarea 1130 of the light emitting area 1100, (as depicted in FIG. 1B). The light emitting area 1100 may have an arbitrary shape, for example, circular (as depicted in FIG. 1A (III, IV), FIG. 1B, and FIG. 2 (V, VI)), rectangular (as depicted in FIG. 1A (I, II), FIG. 2 (I, II, III, IV), and FIG. 3), elliptical or polygonal.

Further, in embodiments, the second subarea 1120 and the third subarea 1130 may at least partially enclose the first subarea 1110. Hence, the first subarea 1110 may have a first outer edge face 1116. The second subarea 1120 may have a second inner edge face 1127 and a second outer edge face 1126. Hence, in embodiments, the first outer edge face 1116 and the second inner edge face 1127 may face each other along at least part of their length. As is depicted in the embodiments in FIGS. 1 and 2, the second subarea 1120 and the third subarea 1130 may (also) fully enclose the first subarea 1110. Hence, in such embodiments, the first outer edge face 1116 and the second inner edge face 1127 may face each other along their full length, i.e., the first outer edge face 1116 and the second inner edge face 1127 may 100% face each other.

Yet further in embodiments, the third subarea 1130 may at least partially enclose the second subarea 1120. Hence, the second subarea 1120 may have a second outer edge face 1126. The third subarea 1130 may have a third inner edge face 1137 and a third outer edge face 1136. Hence, in embodiments, the second outer edge face 1126 and the third inner edge face 1137 may face each other along at least part of their length. As is depicted in the embodiments in FIGS. 1 and 2, the third subarea 1130 may (also) fully enclose the second subarea 1120. Hence, in such embodiments, the second outer edge face 1126 and the third inner edge face 1137 may face each other along their full length, i.e., the second outer edge face 1126 and the third inner edge face 1137 may 100% face each other.

The “lengths” as described here may be defined as the total length (or circumference) of the (inner or outer) face of the respective subarea in a plane perpendicular to the central optical axis Aₒ.

In embodiments, one or more of a spectral power distribution and a luminance of the second system light 1021 may comprise a second gradient over the second subarea 1120. Especially, the second gradient may have a second gradient direction. More especially, in embodiments, the second gradient direction may be a (substantially) tangential direction. Further, the second gradient may have a second gradient magnitude m2.

Likewise, in embodiments, one or more of a spectral power distribution and a luminance of the third system light 1031 may comprise a third gradient over the third subarea 1130. Especially, the third gradient may have a third gradient direction. More especially, in embodiments, the third gradient direction may be a (substantially) tangential direction. Further, the third gradient may have a third gradient magnitude m3.

Here, a tangential (or angular) direction may refer to a direction perpendicular to an (imaginary) radius from the central optical axis Aₒ to a respective point in the respective subarea, i.e. a clockwise or counterclockwise direction about the central optical axis Aₒ.

Further, in embodiments, a luminance comprising a gradient may refer to a (substantially) continuous variation in the luminance from a minimum value to a maximum value or to a variation of luminance from a minimum value to a maximum value in discrete steps. Hence, the term “gradient” may thus be defined as a gradual or stepwise change from a subarea highest (or maximum) value to a subarea lowest (or minimum) value (of the luminance) in a spatial direction. Hence, in embodiments, a luminance (measured in cd/m²) comprising a gradient over a subarea may be defined as a gradual or stepwise change from a subarea highest value to a subarea lowest value (of the luminance) in an angular direction.

The spatial direction over which the gradient may occur, may hence be dependent on a mutual angle α between the point of the subarea highest value and the point of the subarea lowest value relative to the central point P. This mutual angle α may, in embodiments of a stepwise gradient, be divided into smaller angles or gradient steps. In embodiments, a gradient step may thus be defined as a discrete increment within the mutual angle α.

In embodiments, one or more of the following may apply: (i) the second gradient direction and the third gradient direction may be configured anti-parallel or opposite relative to each other, i.e. as shown in FIG. 1A III and IV, and (ii) the second gradient and the third gradient may have a (substantially) different gradient magnitude, and (iii) the second gradient and the third gradient may be shifted in phase relative to each other, i.e. as shown in FIG. 1A I and II (and also in FIG. 1A III and IV). Hence, in embodiments, the second gradient direction and the third gradient direction are configured anti-parallel and the second gradient and the third gradient have (essentially) the same gradient magnitude, such as depicted in FIG. 1A. For example, looking at a subsection of the peripheral part 1160 defined by only the leftmost segments 1125, 1135 and the bottommost segments 1125, 1135 of the square embodiment in FIG. 1A (I), the second gradient has a second subarea highest value and a second subarea lowest value configured such, that the second gradient direction goes from the bottommost second segment 1125 to the leftmost second segment 1125, whereas the third gradient has a third subarea highest value and a third subarea lowest value configured such, that the third gradient direction goes from the leftmost third segment 1135 to the bottommost third segment 1135, i.e., the gradients are configured anti-parallel. In other embodiments, the second gradient direction and the third gradient direction are configured parallel relative to each other and the second gradient and the third gradient have a (substantially) different gradient magnitude, such as depicted in FIG. 2 (V, VI). Looking at FIG. 2 (V), the second gradient has a second subarea highest value configured at a first position 21 and a second subarea lowest value configured at a second position 22, whereas the third gradient has a third subarea highest value configured at a first position 31 and a third subarea lowest value configured at a second position 32, i.e., the gradient are configured parallel. However, in this specific embodiment (V), the second subarea lowest value is higher than the third subarea lowest value, and the second subarea highest value is lower than the third subarea highest value, i.e., the gradients have a (substantially) different gradient magnitude. In yet other embodiments, the second gradient direction and the third gradient direction are configured phase shifted relative to each other and the second gradient and the third gradient have a (substantially) different gradient magnitude (not depicted).

In further embodiments, the light generating system 1000 may be configured to generate system light 1001 (as depicted in FIG. 1B, (I)) comprising first system light 1011, second system light 1021, and third system light 1031. Especially, during operation of the light generating system 1000, in embodiments, the system light 1001 may emanate from at least part of the light emitting area 1100.

Reference P may especially refer to a central point P.

In embodiments, in the first operational mode wherein the second gradient over the second subarea 1120 may have a second gradient direction and the third gradient over the third subarea 1130 may have a third gradient direction, the second gradient direction and the third gradient direction may be configured rotated (or phase shifted) relative to each other. Especially, in embodiments, the second gradient direction and the third gradient direction may be configured rotated (or phase shifted) with an angle selected from the range of 90-270° relative to each other. Particularly, in the embodiments depicted in FIG. 1A and FIG. 2 (I, II, IV), the second gradient direction and the third gradient direction are configured rotated (or phase shifted) with an angle of essentially 180°. Hence, the second gradient direction and the third gradient direction may be configured anti-parallel and phase-shifted with an angle of 180° relative to each other.

Further, in embodiments, the luminance of the second system light 1021 may comprise the second gradient over the second subarea 1120. Especially, the second gradient may have a second gradient direction and a second gradient magnitude m2. Further, in embodiments, the luminance of the third system light 1031 may comprise the third gradient over the third subarea 1130. Especially, the third gradient may have a third gradient direction and a third gradient magnitude m3. Hence, herein a gradient in luminance especially indicates a gradient in luminance while the spectral power distribution does essentially not change.

In further embodiments, the light generating system 1000 may comprise a first subarea 1110, second subarea 1120 and third subarea 1130. Especially, in such embodiments, the second subarea 1120 may be configured between the first subarea 1110 and the third subarea 1130. Hence, in embodiments, the second subarea 1120 may be at least partially adjacent to both the first subarea 1110 and the third subarea 1130. In specific embodiments (such as the embodiments depicted in FIGS. 1 and 2), the second subarea 1120 may be fully enclosed between the first subarea 1110 and the third subarea 1130 (and hence fully adjacent to both the first subarea 1110 and the third subarea 1130).

In yet further embodiments, the light emitting area 1100 may comprise a central part 1150 and a peripheral part 1160. The peripheral part 1160 may, in embodiments, at least partially enclose the central part 1150. Further, in embodiments, the central part 1150 may comprise the first subarea 1110. In such embodiments, the peripheral part 1160 may especially comprise the second subarea 1120 and the third subarea 1130. Especially, in embodiments, an area of the peripheral part 1160 may be selected from the range of 1-50% of a total area of the light emitting area 1100. In other embodiments, an area of the peripheral part 1160 may be selected from the range of 50-99% of a total area of the light emitting area 1100.

FIG. 1B (I) especially schematically depicts a cross-section of an embodiment, wherein the light generating system 1000 may comprise one or more first light generating devices 110, one or more second light generating devices 120, and one or more third light generating devices 130.

Especially, in embodiments, the one or more first light generating devices may be configured to generate first device light 111. The first device light 111 may especially, in embodiments, be comprised by the first system light 1011. Further, in embodiments, the one or more first light generating devices 110 may comprise one or more (first) solid state light sources 10.

Further, the one or more second light generating devices 120 may be configured to generate second device light 121. The second device light 121 may especially, in embodiments, be comprised by the second system light 1021. Further, in embodiments, the one or more second light generating devices 120 may comprise a plurality of (second) solid state light sources 10.

Yet further, in embodiments, the one or more third light generating devices 130 may be configured to generate third device light 131. The third device light 131 may especially, in embodiments, be comprised by the third system light 1031. Further, in embodiments, the one or more third light generating devices 130 may comprise a plurality of (third) solid state light sources 10.

However, in embodiments not depicted here, the light generating system 1000 may also comprise a 2D array of solid state light sources 10. Especially, the said 2D array of solid state light sources 10 may comprise the one or more (first) solid state light sources 10, the plurality of (second) solid state light sources 10, and the plurality of (third) solid state light sources 10.

Furthermore, in embodiments, the one or more second light generating devices 120 may comprise LED filaments. In other embodiments, the one or more second light generating devices 120 may comprise LED strips. In yet other embodiments, the one or more second light generating devices 120 may comprise both LED filaments and LED strips.

Likewise, in embodiments, the one or more third light generating devices 130 may comprise LED filaments. In other embodiments, the one or more third light generating devices 130 may comprise LED strips. In yet other embodiments, the one or more third light generating devices 130 may comprise both LED filaments and LED strips.

FIG. 1B (II) schematically depicts an isometric view of another embodiment of the light generating system 1000. Especially, in said embodiment, the one or more second light generating devices 120 may enclose the one or more first light generating devices 110. Further, in embodiments, the one or more third light generating devices 130 may enclose the one or more second light generating devices 120.

In embodiments, the light generating system 1000 may comprise a diffuser 510 (as depicted in FIG. 1B, (I)). Especially, the diffuser 510 may, embodiments, be configured downstream of the one or more first light generating devices 110, the one or more second light generating devices 120, and the one or more third light generating devices 130. More especially, in embodiments, the diffuser 510 may comprise the light emitting area 1100.

In embodiments the light generating system 1000 may comprise a control system 300. Especially, the control system 300 may, in embodiments, be configured to control the first system light 1011. Further, in embodiments, the control system 300 may be configured to control the second system light 1021. Yet further, in embodiments, the control system 300 may be configured to control the third system light 1031.

The control system 300 may, in embodiments, at least be configured to control the luminance of the second system light 1021 and the luminance of the third system light 1031.

In further embodiments, the control system 300 may be configured to control the (first system light 1011, the) second system light 1021, and the third system light 1031. Especially, the control system 300 may be configured to, in embodiments, control the (first system light 1011, the) second system light 1021, and the third system light 1031 in dependence of one or more of time and outdoor lighting conditions.

Additionally or alternatively, the control system 300 may be configured to, in embodiments, control the (first system light 1011, the) second system light 1021, and the third system light 1031 in dependence of indoor lighting conditions.

In yet further embodiments, the light generating system 1000 may further comprise a sensor 310. The sensor 310 may, in embodiments, be configured to sense one or more of presence and movement of a human. Further, in embodiments, the sensor 310 may generate a sensor signal related to the sensed presence and/or movement of a human.

In embodiments, the control system 300 may be configured to control (the first system light 1011) the second system 1021 light and the third system light 1031 in dependence of the sensor signal.

In embodiments, in the first operational mode of the light generating system 1000, the first system light 1011 may have a color point within 20 standard deviation of color matching from the black body locus.

Further, in such embodiments, the second system light 1021 may (also) have a color point within 20 standard deviation of color matching from the black body locus.

Yet further, in such embodiments, the third system light 1031 may (also) have a color point within 20 standard deviation of color matching from the black body locus.

In embodiments, one or more of (especially both) the spectral power distribution and the luminance of the first system light 1011 may not comprise or may be free from a first gradient over the first subarea 1110.

As shown in FIG. 1A, the second subarea 1120 and the third subarea 1130 are concentrically arranged without any (non-illuminated) space in between the second and third subarea, i.e. the second subarea and third subarea touch each other over their full circumference.

FIG. 2 schematically depicts some more embodiments of the invention. Especially, in the depicted embodiments III, and IV, the second subarea 1120 (comprised by the light emitting area 1100) may comprise two or more (second) segments 1125 (as also depicted in FIG. 1A). In such embodiments, second system light 1021 may, in the first operational mode, emanate from the two or more (second) segments 1125. The said second system light 1021 emanating from the two or more (second) segments 1125, may, in embodiments, differ in one or more of spectral power distribution and luminance.

In embodiments, the two or more second segments 1125 may not have an intersegmental gradient. Hence, the two or more second segments 1125 may contribute to the second gradient solely through intersegmental differences in luminance and/or spectral power distribution. For example, in the embodiments depicted in FIG. 1A (I, II) and FIG. 2 (III, IV), the four depicted second segments 1125 comprise solely intersegmental differences in e.g. luminance.

However, in other embodiments, the two or more second segments 1125 may have an (additional) intersegmental gradient. Hence, the two or more second segments 1125 may contribute to the second gradient through both intersegmental and intersegmental differences in luminance and/or spectral power distribution, not depicted here.

Further, in embodiments, the third subarea 1130 (comprised by the light emitting area 1100) may comprise two or more (third) segments 1135 (as also depicted in FIG. 1A). In such embodiments, third system light 1031 may, in the first operational mode, emanate from the two or more (third) segments 1135. The said third system light 1031 emanating from the two or more (third) segments 1135, may, in embodiments, differ in one or more of spectral power distribution and luminance.

In embodiments, the two or more third segments 1135 may not have an intersegmental gradient. Hence, the two or more third segments 1135 may contribute to the third gradient solely through intersegmental differences in luminance and/or spectral power distribution. For example, in the embodiments depicted in FIG. 1A (I, II) and FIG. 2 (III, IV), the four depicted third segments 1135 comprise solely intersegmental differences in e.g. luminance. FIG. 2 (III, IV) especially differs from FIG. 1A (I, II) in that the intersegmental variation between the (second and third) segments is oriented differently. Especially, in FIG. 2 (III), unlike in FIG. 1A (I, II), the second segments 1125 decrease in luminance in steps of clockwise rotation, while the third segments 1135 decrease in luminance in steps of counterclockwise rotation. Further, in FIG. 2 (IV) the second segments 1125 and the third segments 1135 all decrease in luminance in steps of counterclockwise rotation.

However, in other embodiments, the two or more third segments 1135 may have an (additional) intersegmental gradient. Hence, the two or more third segments 1135 may contribute to the third gradient through both intersegmental and intersegmental differences in luminance and/or spectral power distribution, not depicted here.

FIG. 2 (I, II) depicts some variations on the circular embodiments in FIG. 1A (III, IV). Especially, FIG. 2 (I, II) depicts square embodiments where with a continuous second gradient and third gradient. Especially, FIG. 2 (I) depicts as square shaped version of FIG. 1A. (IV), whereas FIG. 2 (II) depicts a similar square shaped version, but with the second gradient and the third gradient phase-shifted relative to each other.

FIG. 2 (V, VI) further depicts some variations on the circular embodiments in FIG. 1A (III, IV). Especially, FIG. 2 (V, VI) depicts circular embodiments where the second gradient direction and the third gradient direction are configured parallel, i.e., not rotated (or phase shifted) relative to each other, but wherein the second gradient magnitude and the third gradient magnitude are different. Embodiment V especially depicts a light generating system 1000 where the second subarea 1120 comprises a gradient with a smaller gradient magnitude than the gradient comprised by the third subarea 1130. On the other hand, embodiment VI especially depicts a light generating system 1000 where the second subarea 1120 comprises a gradient with a larger gradient magnitude than the gradient comprised by the third subarea 1130.

In embodiments, the first gradient and the second gradient may be defined tangential. Hence, FIG. 3 depicts some more embodiments of the invention. Especially, FIG. 3 (I, III) depict square shaped embodiments as discussed above. More especially, FIG. 3 (II, IV) depict rectangular shaped embodiments analogous to the square shaped embodiments (I, III). Hence, embodiments II, IV depict an in one direction elongated version of embodiments I, III.

Further, in embodiments, the second gradient magnitude m2 may be defined by a difference in luminance ΔL2 between a first position p21 in the second subarea 1120 having a subarea lowest second luminance L21 and a second position p22 in the second subarea 1120 having a subarea highest second luminance L22 divided by a mutual angle α2 between the first position p21 and the second position p22 relative to a central point P in the first subarea 1110, wherein L21/L22≤0.5. Additionally or alternatively, the third gradient magnitude m3 may be defined by a difference in luminance ΔL3 between a first position p31 in the third subarea 1120 having a subarea lowest third luminance L31 and a second position p32 in the third subarea 1120 having a subarea highest third luminance L32 divided by a mutual angle 3 between the first position p31 and the second position p32 relative to the central point P in the first subarea 1110, wherein L31/L32≤0.5. Especially, in the embodiments depicted in FIG. 3 (and FIG. 2 (V, VI)), the mutual angles are all 180°. Hence, in the embodiments depicted in FIG. 2 (V, VI), the light emitting surface 1100 comprises a (second and third) subarea (1120, 1130) spanning 180° of a circle (i.e. the mutual angle α is 180°), and another (second and third) subarea (1120, 1130) spanning the other 180° of the circle (i.e. the mutual angle α is 180°). Likewise, in another example as depicted in FIG. 3, the light emitting surface 1100 may comprise a (second and third) subarea (1120, 1130) spanning two sides of a square embodiment (i.e. spanning a mutual angle α of 180°), and another (second and third) subarea (1120, 1130) spanning the other two sides of the square embodiment (i.e. spanning a mutual angle α of 180°). In other embodiments (not depicted here), for example, the light emitting surface 1100 may comprise a second (or third) subarea 1120 spanning 135° of a circle, and another second (or third) subarea 1120 (1130) spanning the other 225° of the circle. In a yet further example, the light emitting surface 1100 may comprise a second (or third) subarea 1120 spanning 135° of a ¾^{th} circle, and another second (or third) subarea 1120 spanning another 135° of the ¾^{th} circle.

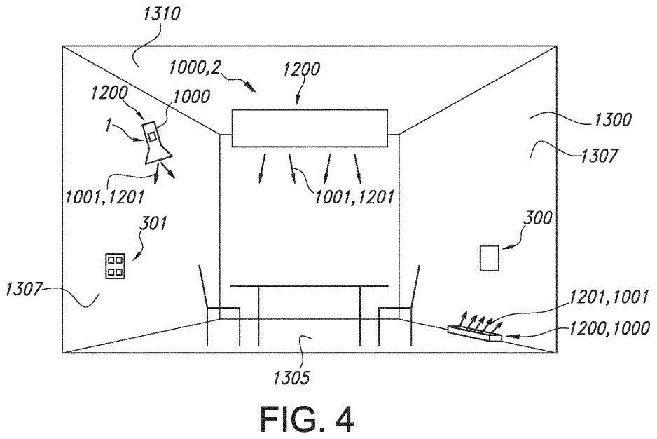

FIG. 4 schematically depicts an embodiment of the lighting device 1200 comprising the light generating system 1000 as described above. In embodiments, the invention may provide an indoor space 1300 comprising a ceiling 1310 and the light generating system 1000. Especially, the light emitting area 1100 may be functionally coupled to the ceiling 1310. Furthermore, in embodiments, the light generating system may further comprise the control system 300 and sensor 310. Hence, FIG. 4 schematically depicts embodiments of a lighting device 1200 selected from the group of a lamp 1, a luminaire 2, a disinfection device, and an optical wireless communication device, comprising the light generating system 1000 as described herein. In embodiments, such lighting device may be a lamp 1, a luminaire 2, a disinfection device, or an optical wireless communication device. Lighting device light escaping from the lighting device 1200 is indicated with reference 1201. Lighting device light 1201 may essentially consist of system light 1001, and may in specific embodiments thus be system light 1001. In embodiments, the light generating device 1200 may be configured provide system light 1001 on one or more surfaces in a room 1300. Especially, the light generating system 1000 may illuminate the walls 1307, or the floor 1305, or the ceiling 1310 in a room 1300. Reference 301 indicates a user interface which may be functionally coupled with the control system 300 comprised by or functionally coupled to the light generating system 1000.

The term “plurality” refers to two or more. The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%. The term “comprise” also includes embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the operational modes as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A light generating system comprising a light emitting area, wherein the light generating system is configured such that in a first operational mode of the light generating system first system light emanates from a first subarea of the light emitting area, second system light emanates from a second, ring-shaped subarea of the light emitting area, and third system light emanates from a third, ring-shaped subarea of the light emitting area; wherein:
the second subarea and the third subarea at least partially enclose the first subarea, and wherein the third subarea at least partially encloses the second subarea;
one or more of a spectral power distribution and a luminance of the second system light comprises a second gradient over the second ring-shaped subarea, having a second gradient direction in a circumferential direction and a second gradient magnitude m2, the second gradient comprises only a single period over the whole second ring-shaped subarea;
one or more of a spectral power distribution and a luminance of the third system light comprises a third gradient over the third ring-shaped subarea, having a third gradient direction in a circumferential direction and a third gradient magnitude m3, the third gradient comprises only a single period over the whole third ring-shaped subarea; and
one or more of the following applies: (i) the second gradient direction and the third gradient direction are configured opposite relative to each other, (ii) the second gradient and the third gradient have a different gradient magnitude, and (iii) the second gradient and the third gradient are shifted in periodic phase relative to each other.

2. The light generating system according to claim 1, wherein the second gradient direction and the third gradient direction are configured in the same circumferential direction and are phase-shifted with an angle of 180° relative to each other.

3. The light generating system according to claim 1, wherein a first gradient and the second gradient are defined tangential; wherein the second gradient magnitude m2 is defined by a difference in luminance ΔL2 between a first position (p21) in the second subarea having a subarea lowest second luminance L21 and a second position (p22) in the second subarea having a subarea highest second luminance L22 divided by a mutual angle (α2) between the first position (p21) and the second position (p22) relative to a central point (P) in the first subarea, wherein L21/L22≤0.5, and/or wherein the third gradient magnitude m3 is defined by a difference in luminance ΔL3 between a first position (p31) in the third subarea having a subarea lowest third luminance L31 and a third position (p32) in the third subarea having a subarea highest third luminance L32 divided by a mutual angle (α3) between the first position (p31) and the third position (p32) relative to the central point (P) in the first subarea, wherein L31/L32≤0.5.

4. The light generating system according to claim 1, wherein m2/m3≥3/2 or wherein m2/m3≤2/3.

5. The light generating system according to claim 1, wherein the light emitting area comprises a central part and a peripheral part, at least partially enclosing the central part, wherein the central part comprises the first subarea, and wherein the peripheral part comprises the second subarea and the third subarea; wherein an area of the peripheral part is selected from the range of 1-50% of a total area of the light emitting area.

6. The light generating system according to claim 1, comprising:
one or more first light generating devices configured to generate first device light, wherein the first system light comprises the first device light;
one or more second light generating devices configured to generate second device light, wherein the second system light comprises the second device light; wherein the one or more second light generating devices comprise a plurality of solid state light sources; and
one or more third light generating devices configured to generate third device light, wherein the third system light comprises the third device light; wherein the one or more third light generating devices comprise a plurality of solid state light sources.

7. The light generating system according to claim 6, wherein the one or more second light generating devices comprise one or more of (a) a LED filament and (b) a LED strip; and wherein the one or more third light generating devices comprise one or more of (a) a LED filament and (b) a LED strip; wherein the second subarea is configured between the first subarea and the third subarea.

8. The light generating system according to claim 5 and according to claim 6, wherein the one or more second light generating devices enclose the one or more first light generating devices, and wherein the one or more third light generating devices enclose the one or more second light generating devices.

9. The light generating system according to claim 6, comprising a diffuser, wherein the diffuser is configured downstream of the one or more first light generating devices, the one or more second light generating devices, and the one or more third light generating devices; and wherein the diffuser comprises the light emitting area, wherein downstream is relatively further away from the light generating device with respect to propagation of a beam of light from the light generating device.

10. The light generating system according to claim 1, further comprising a control system configured to control the second system light, and the third system light.

11. The light generating system according to claim 10, wherein the control system is at least configured to control the luminance of the second system light and the luminance of the third system light.

12. The light generating system according to claim 10, wherein the control system is configured to control the second system light, and the third system light in dependence of one or more of time and outdoor lighting conditions.

13. The light generating system according to claim 10, further comprising a sensor, wherein the sensor is configured to sense one or more of presence and movement of a human and to generate a related sensor signal, wherein the control system is configured to control the second system light, and the third system light in dependence of the sensor signal.

14. The light generating system according to claim 1, wherein in a first operational mode of the light generating system the first system light, the second system light, and the third system light all have a color point within 20 standard deviation of color matching from the black body locus, wherein both a spectral power distribution and a luminance of the first system light do not comprise a first gradient over the first subarea.

15. A lighting device selected from the group of a lamp (1), a luminaire (2), a disinfection device, and an optical wireless communication device, comprising the light generating system according to claim 1.
